(19) United States
(12) Patent Application Publication
(10) Pub. No.: US 2025/0002400 A1
(43) Pub. Date: Jan. 2, 2025

(54) DISPLAY DEVICE INCLUDING WINDOW AND METHOD FOR MANUFACTURING WINDOW

(71) Applicant: Samsung Display Co., LTD., Yongin-si, Gyeonggi-do (KR)

(72) Inventors: Jiin YOON, Yongin-si, Gyeonggi-do (KR); MYUNG-HWAN KIM, Yongin-si, Gyeonggi-do (KR); TAE-SIK KIM, Yongin-si, Gyeonggi-do (KR); JINNYOUNG HEO, Yongin-si, Gyeonggi-do (KR)

(21) Appl. No.: 18/592,998

(22) Filed: Mar. 1, 2024

(30) Foreign Application Priority Data
May 26, 2023 (KR) 10-2023-0068687

(51) Int. Cl. C03C 17/32

(52) U.S. Cl. CPC C03C 17/32; C03C 2217/78; C03C 2218/112

(57) ABSTRACT

A method for manufacturing a window includes performing a plasma treatment on a surface of a substrate, performing a first application operation to form a first portion by applying a first solution onto the substrate, performing a second application operation to form a second portion by applying a second solution onto the first portion, performing a third application operation to form a third portion by applying a third solution onto the second portion, and forming a first coating layer by simultaneously curing the first to third portions.

This application claims priority to Korean Patent Application No. 10-2023-0068687, filed on May 26, 2023, and all the benefits accruing therefrom under 35 U.S.C. § 119, the content of which in its entirety is herein incorporated by reference.

### BACKGROUND

### 1. Field

Embodiments of the disclosure described herein relate to a display device including a window having improved impact resistance and flatness and a method for manufacturing the window.

### 2. Description of the Related Art

A display device provides information to a user by displaying various images on a display screen. In general, the display device displays information within an assigned screen. Recently, a flexible display device including a flexible display panel that is foldable is being developed. The flexible display device may include a flexible window. Unlike a rigid display device, the flexible display device may be folded, rolled, or bent. The flexible display device whose shape may be variously changed to be in a size less than a screen size in an unfolded state, so that user convenience may be improved.

### SUMMARY

Embodiments of the disclosure provide a display device including a window having improved impact resistance and flatness and a method for manufacturing the window.

According to an embodiment, a method for manufacturing a window includes performing a plasma treatment on a surface of a substrate, performing a first application operation to form a first portion by applying a first solution onto the substrate, performing a second application operation to form a second portion by applying a second solution onto the first portion, performing a third application operation to form a third portion by applying a third solution onto the second portion, and forming a first coating layer by simultaneously curing the first to third portions.

In an embodiment, the first solution and the second solution may include a same material as each other.

In an embodiment, the first portion may have a thickness in a range from about 6.7 micrometers (μm) to about 10 μm, the second portion may have a thickness in a range from about 6.7 μm to about 10 μm, and the third portion may have a thickness in a range from about 6.7 μm to about 10 μm.

In an embodiment, the performing the first application operation may include applying the first solution along a path in a zigzag shape along a first direction by using a spray coating method.

In an embodiment, the performing the second application operation may use the spray coating method, and the second application operation may include applying the second solution along a path in the zigzag shape along a direction opposite to the first direction by using the spray coating method.

In an embodiment, the method may further include forming a second coating layer on the first coating layer after the forming of the first coating layer.

In an embodiment, the forming of the second coating layer may include performing the plasma treatment on a surface of the first coating layer, forming a fourth portion by applying a fourth solution onto the first coating layer, forming a fifth portion by applying a fifth solution onto the fourth portion, forming a sixth portion by applying a sixth solution onto the fifth portion, and simultaneously curing the fourth to sixth solutions.

In an embodiment, each of the first coating layer and the second coating layer may have a thickness in a range from about 20 μm to about 40 μm.

In an embodiment, the method may further include forming a third coating layer under the substrate after the forming the first coating layer.

According to an embodiment, a method for manufacturing a window includes performing a plasma treatment on a surface of a substrate, performing a first application operation to form a first portion by applying a first solution onto the substrate, forming a first layer by curing the first portion, performing the plasma treatment on a surface of the first layer, performing a second application operation to form a second portion by applying a second solution onto the first layer, and curing the second portion to form a second layer, where the first layer and the second layer collectively define a first coating layer.

In an embodiment, the first layer may have a thickness in a range from about 10 μm to about 15 μm.

In an embodiment, the second layer may have a thickness in a range from about 10 μm to about 15 μm.

In an embodiment, the first solution may not include a leveling agent, and the second solution may include the leveling agent.

In an embodiment, the performing the first application operation may include applying the first solution along a path in a zigzag shape along a first direction by using a spray coating method.

In an embodiment, the performing the second application operation may include applying the second solution along a path in the zigzag shape along the first direction by using the spray coating method.

In an embodiment, the method may further include forming a second coating layer under the substrate after the forming the first layer and the forming the second layer.

According to an embodiment, a display device includes a display panel, and a window disposed on the display panel, where the window includes a substrate, and a first coating layer disposed on the substrate, the first coating layer is a solid layer formed by curing a solution, the solution has a viscosity in a range from about 6 centipoise cps (cps) to 10 cps, and a difference between a maximum value and a minimum value (a peak to valley (PV) value) of a wavefront aberration of the first coating layer is equal to or greater than 0.2 wavelength and equal to or smaller than 0.92 wavelength.

In an embodiment, the first coating layer may have a thickness in a range from about 20 μm to about 30 μm.

In an embodiment, the first coating layer may include a first layer and a second layer stacked one on another therein, and the first layer and the second layer may include a same material as each other.

In an embodiment, the display device may further include a second coating layer disposed under the substrate and opposite the first coating layer.

### BRIEF DESCRIPTION OF THE DRAWINGS

The above and other features of embodiments of the disclosure will become apparent by describing in detail embodiments thereof with reference to the accompanying drawings.

FIG. 1A is a perspective view of an unfolded electronic device according to an embodiment of the disclosure.

FIG. 1B is a perspective view of a folded electronic device according to an embodiment of the disclosure.

FIG. 2 is an exploded perspective view of an electronic device according to an embodiment of the disclosure.

FIG. 3 is a cross-sectional view of a display device and a camera module taken along line I-I′ in FIG. 2 according to an embodiment of the disclosure.

FIG. 4 is a cross-sectional view showing a display panel according to an embodiment of the disclosure.

FIG. 5 is a flowchart illustrating a window manufacturing method according to an embodiment of the disclosure.

FIG. 6A is a perspective view showing a process of a window manufacturing method according to an embodiment of the disclosure.

FIG. 6B is a perspective view showing a process of a window manufacturing method according to an embodiment of the disclosure.

FIG. 6C is a cross-sectional view of a preliminary window cut along a line corresponding to II-II′ in FIG. 1A according to an embodiment of the disclosure.

FIG. 6D is a perspective view showing a process of a window manufacturing method according to an embodiment of the disclosure.

FIG. 6E is a cross-sectional view of a preliminary window cut along a line corresponding to II-II′ in FIG. 1A according to an embodiment of the disclosure.

FIG. 6F is a perspective view showing a process of a window manufacturing method according to an embodiment of the disclosure.

FIG. 6G is a cross-sectional view of a preliminary window cut along a line corresponding to II-II′ in FIG. 1A according to an embodiment of the disclosure.

FIG. 6H is a perspective view showing a process of a window manufacturing method according to an embodiment of the disclosure.

FIG. 6I is a perspective view showing a process of a window manufacturing method according to an embodiment of the disclosure.

FIG. 6J is a perspective view showing a window according to an embodiment of the disclosure.

FIG. 7A is a graph showing a thickness of a coating layer based on a distance from an edge of a substrate according to an embodiment of the disclosure.

FIG. 7B is a graph showing a thickness of a coating layer based on a distance from an edge of a substrate according to an embodiment of the disclosure.

FIG. 8A is a box graph showing a PV value based on the number of times of application according to an embodiment of the disclosure.

FIG. 8B shows captured images of a window based on number of times of application according to an embodiment of the disclosure.

FIG. 9A is a box graph showing a PV value based on the number of times of application according to an embodiment of the disclosure.

FIG. 9B may show captured images of a window based on the number of times of application according to an embodiment of the disclosure.

FIG. 10 is a flowchart illustrating a window manufacturing method according to an embodiment of the disclosure.

FIG. 11A is a perspective view showing a process of a window manufacturing method according to an embodiment of the disclosure.

FIG. 11B is a perspective view showing a process of a window manufacturing method according to an embodiment of the disclosure.

FIG. 11C is a cross-sectional view of a preliminary window cut along a line corresponding to II-II′in FIG. 1A according to an embodiment of the disclosure.

FIGS. 11D to 11F are perspective views showing one step of a window manufacturing method according to an embodiment of the disclosure.

FIG. 11G is a cross-sectional view of a preliminary window cut along a line corresponding to II-II′ in FIG. 1A according to an embodiment of the disclosure.

FIG. 11H is a perspective view showing a process of a window manufacturing method according to an embodiment of the disclosure.

FIGS. 11I and 11J are perspective views showing a process of a window manufacturing method according to an embodiment of the disclosure.

FIG. 12A is a box graph showing a PV value based on the number of layers of a coating layer according to an embodiment of the disclosure.

FIG. 12B shows captured images of a window based on the number of layers of a coating layer according to an embodiment of the disclosure.

FIG. 13 is a box graph showing a PV value of a window formed using multi-stage coating and multi-layer coating methods according to an embodiment of the disclosure.

FIG. 14 is a flowchart showing a window manufacturing method according to an embodiment of the disclosure.

FIGS. 15A to 15M are perspective views showing a process of a window manufacturing method according to an embodiment of the disclosure.

FIG. 16A is a box graph showing a PV value for each coating method according to an embodiment of the disclosure.

FIG. 16B shows captured images of a window for each coating method according to embodiments of the disclosure.

FIGS. 17A to 17F show windows according to embodiments of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

Herein, when a component (or a region, a layer, a portion, and the like) is referred to as being “on”, “connected to”, or “coupled to” another component, it means that the component may be directly disposed/connected/coupled on another component or a third component may be disposed between the component and another component.

Like reference numerals refer to like components. In addition, in the drawings, thicknesses, ratios, and dimensions of components are exaggerated for effective description of technical content.

Terms such as first, second, and the like may be used to describe various components, but the components should not be limited by the terms. The above terms are used only for the purpose of distinguishing one component from another. For example, without departing from the scope of the disclosure, a first component may be named as a second component, and similarly, the second component may also be named as the first component.

In addition, terms such as “beneath”, “under”, “below”, “on”, “above” are used to describe the relationship of the components shown in the drawings. The above terms are relative concepts, and are described with reference to directions indicated in the drawings.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the disclosure will be described in detail with reference to drawings.

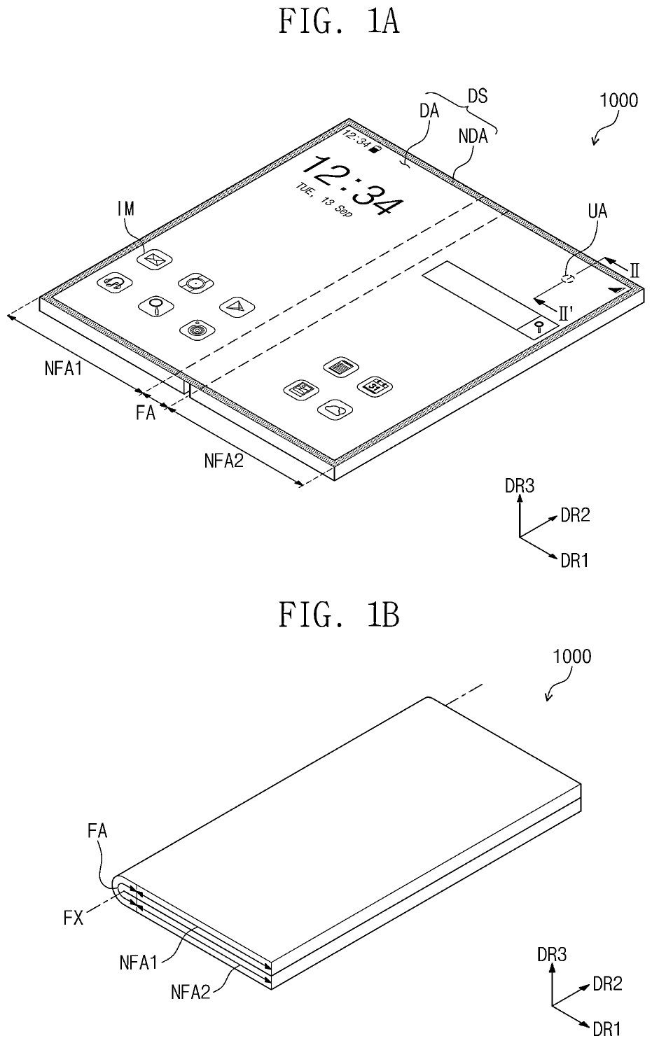

FIG. 1A is a perspective view of an unfolded electronic device according to an embodiment of the disclosure, and FIG. 1B is a perspective view of a folded electronic device according to an embodiment of the disclosure.

Referring to FIGS. 1A and 1B, an embodiment of an electronic device 1000 may include a display surface DS defined by a first direction DR1 and a second direction DR2 intersecting the first direction DR1. The electronic device 1000 may provide an image IM to a user via the display surface DS.

The display surface DS may include a display area DA and a non-

display area NDA around the display area DA. The display area DA may display the image IM, and the non-display area NDA may not display the image IM. The non-display area NDA may surround the display area DA. However, the disclosure may not be limited thereto, and a shape of the display area DA and a shape of the non-display area NDA may be variously modified.

Hereinafter, a direction substantially perpendicular to a plane defined by the first direction DR1 and the second direction DR2 may be defined as a third direction DR3. The third direction DR3 may be a thickness direction of the electronic device 1000. In addition, herein, “on a plane” or “when viewed in a plan view” may be defined as a state viewed in the third direction DR3.

A sensor area UA may be defined in the display area DA of the electronic device 1000. Although an embodiment where a single sensor area UA is provided illustrated as an example in FIG. 1A, the number of sensor areas UA is not limited thereto. The sensor area UA may be a portion of the display area DA. The electronic device 1000 may display the image IM via the sensor area UA.

An electronic module may be disposed in an area overlapping the sensor area UA on a plane. The electronic module may receive an external input transmitted via the sensor area UA or provide an output via the sensor area UA. In an embodiment, for example, the electronic module may include a camera module, a sensor for measuring a distance such as a proximity sensor, a sensor for recognizing a body part (e.g., a fingerprint, an iris, or a face) of the user, a small lamp for outputting light or the like, but may not be particularly limited.

In an embodiment of the electronic device 1000, a foldable area FA and a plurality of non-foldable areas NFA1 and NFA2 may be defined. The plurality of non-foldable areas NFA1 and NFA2 may include the first non-foldable area NFA1 and the second non-foldable area NFA2. The foldable area FA may be disposed between the first non-foldable area NFA1 and the second non-foldable area NFA2. The foldable area FA may be referred to as a foldable area, and the first and second non-foldable areas NFA1 and NFA2 may be referred to as first and second non-foldable areas, respectively.

The foldable area FA may be folded based on a folding axis FX parallel to the second direction DR2. When the electronic device 1000 is folded, the foldable area FA may have a predetermined curvature or a predetermined radius of curvature. The first non-foldable area NFA1 and the second non-foldable area NFA2 may face each other in the folded state, and the electronic device 1000 may be in-folded such that the display surface DS is not exposed to the outside.

The electronic device 1000 according to an embodiment of the disclosure may be out-folded such that the display surface DS is exposed to the outside. In an embodiment of the disclosure, the electronic device 1000 may be in-folded or out-folded from an unfolding operation, but may not be limited thereto. In an embodiment of the disclosure, the electronic device 1000 may be constructed to select one of the unfolding operation, the in-folding operation, and the out-folding operation. In an embodiment of the disclosure, a plurality of folding axes may be defined in the electronic device 1000, and the electronic device 1000 may be in-folded or out-folded from the unfolding operation at each of the plurality of folding axes.

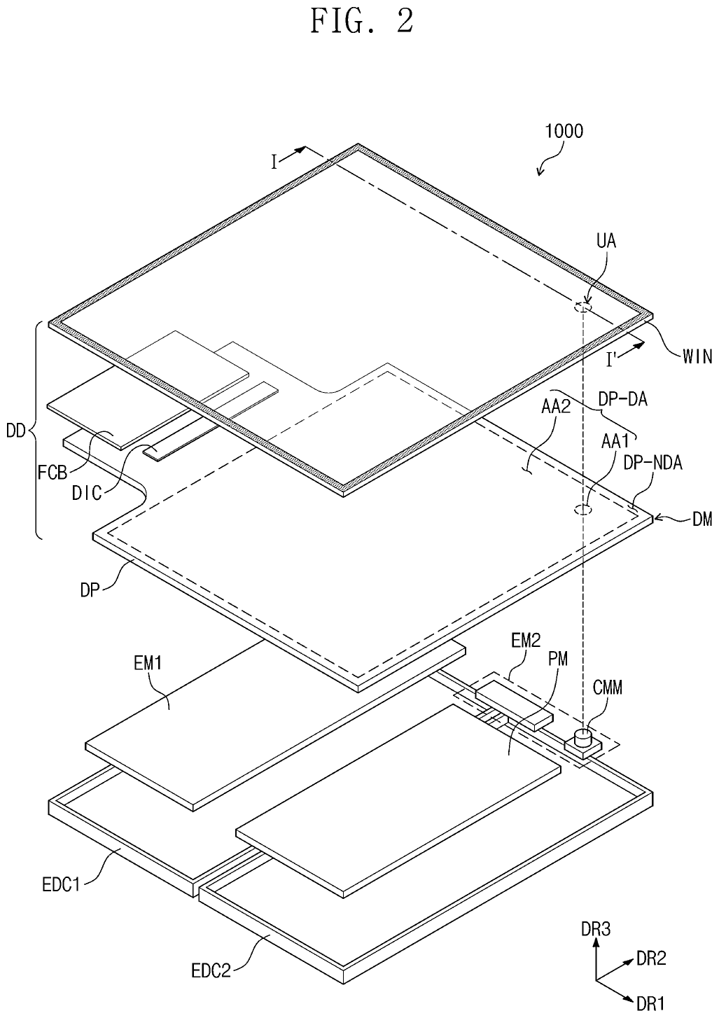

FIG. 2 is an exploded perspective view of an electronic device according to an embodiment of the disclosure.

Referring to FIG. 2, an embodiment of the electronic device 1000 may include a display device DD, a first electronic module EM1, a second electronic module EM2, a power supply module PM, and housings EDC1 and EDC2. The electronic device 1000 may further include a mechanism structure for controlling a folding operation of the display device DD.

The display device DD may include a window WIN and a display module DM. The window WIN may provide a front surface of the electronic device 1000. The display module DM may include at least a display panel DP. The display module DM may generate the image and sense the external input.

The display module DM may have a stacked structure in which a plurality of components including the display panel DP are stacked. The stacked structure of the display module DM will be described later.

In an embodiment of the display panel DP, a display area DP-DA and a non-display area DP-NDA respectively corresponding to the display area DA (see FIG. 1A) and the non-display area NDA (see FIG. 1A) of the electronic device 1000 may be defined. Herein, “an area/a portion and an area/a portion correspond to each other” means that they overlap each other, but are not limited to a case having a same area or size as each other.

The display area DP-DA may include a first area AA1 and a second area AA2. The first area AA1 may overlap or correspond to the sensor area UA (see FIG. 1A) of the electronic device 1000. In an embodiment of the disclosure, as shown in FIG. 2, the first area AA1 may have a circular shape, but the disclosure is not limited thereto. In an embodiment, for example, the first area AA1 may have various shapes, such as a polygon, an ellipse, a figure having at least one curved side, or an irregular shape, but the disclosure may not be limited to one embodiment. The first area AA1 may be referred to as a component area, and the second area AA2 may be referred to as a main display area or a general display area.

The first area AA1 may have greater transmittance than the second area AA2. In an embodiment, a resolution of the first area AA1 may be smaller than that of the second area AA2. However, this is merely an example, and the first area AA1 according to an embodiment of the disclosure may have the greater transmittance than the second area AA2, but the resolution of first area AA1 may be substantially the same as that of the second area AA2.

On a plane, the first area AA1 may overlap a camera module CMM to be described later. A portion of the display panel DP corresponding to the first area AA1 according to an embodiment of the disclosure may be removed.

The display module DM may include a driving chip DIC disposed on the non-display area DP-NDA. The display module DM may further include a flexible circuit film FCB coupled to the non-display area DP-NDA.

The driving chip DIC may include driving elements, for example, a data driving circuit, for driving pixels of the display panel DP. Although FIG. 2 shows an embodiment having a structure in which the driving chip DIC is mounted on the display panel DP, the disclosure is not limited thereto. In an embodiment, for example, the driving chip DIC may be mounted on the flexible circuit film FCB.

The power supply module PM supplies power used for overall operation of an electronic device EDE. The power supply module PM may include a conventional battery module.

The first electronic module EM1 and the second electronic module EM2 include various functional modules for operating the electronic device EDE. Each of the first electronic module EM1 and the second electronic module EM2 may be directly mounted on a motherboard electrically connected to the display panel DP or mounted on a separate board and electrically connected to the motherboard via a connector (not shown). The first electronic module EM1 may include a control module, a wireless communication module, an image input module, an audio input module, a memory, an external interface, or the like.

The second electronic module EM2 may include an audio output module, a light emitting module, a light receiving module, the camera module CMM, or the like.

The camera module CMM may take a still image and a moving image. The camera module CMM may include a plurality of camera modules. Among them, some camera modules CMM may overlap the first area AA1. The external input (e.g., light) may be provided to the camera module CMM via the first area AA1. In an embodiment, for example, the camera module CMM may capture an external image by receiving external light via the first area AA1.

The housings EDC1 and EDC2 accommodate the display module DM, the first and second electronic modules EM1 and EM2, and the power supply module PM therein. The housings EDC1 and EDC2 protect components accommodated in the housings EDC1 and EDC2, such as the display module DM, the first and second electronic modules EM1 and EM2, and the power supply module PM. FIG. 2 shows an embodiment including two housings EDC1 and EDC2 separated from each other as an example, but the disclosure is not limited thereto. Although not shown, the electronic device EDE may further include a hinge structure for connecting the two housings EDC1 and EDC2 to each other. The housings EDC1 and EDC2 may be coupled to a window module WM.

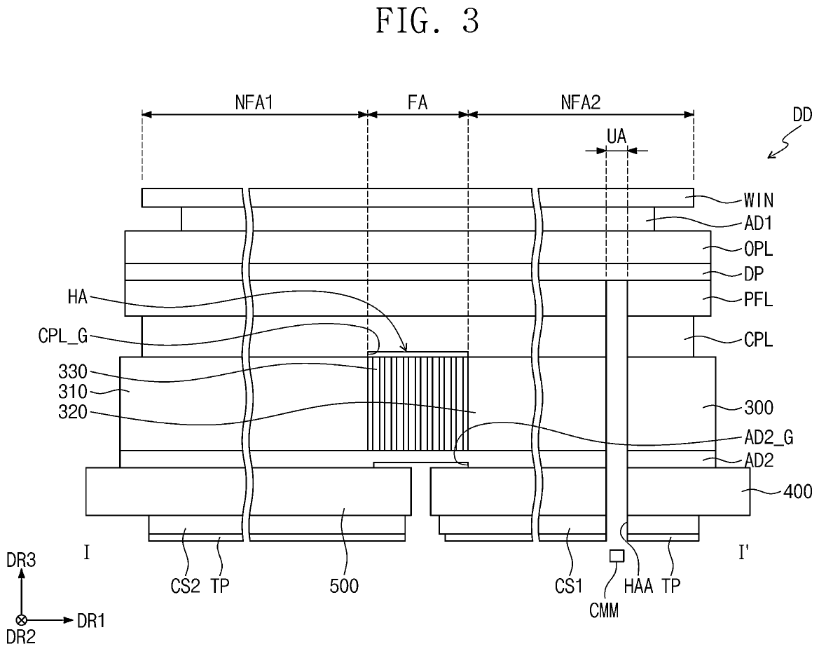

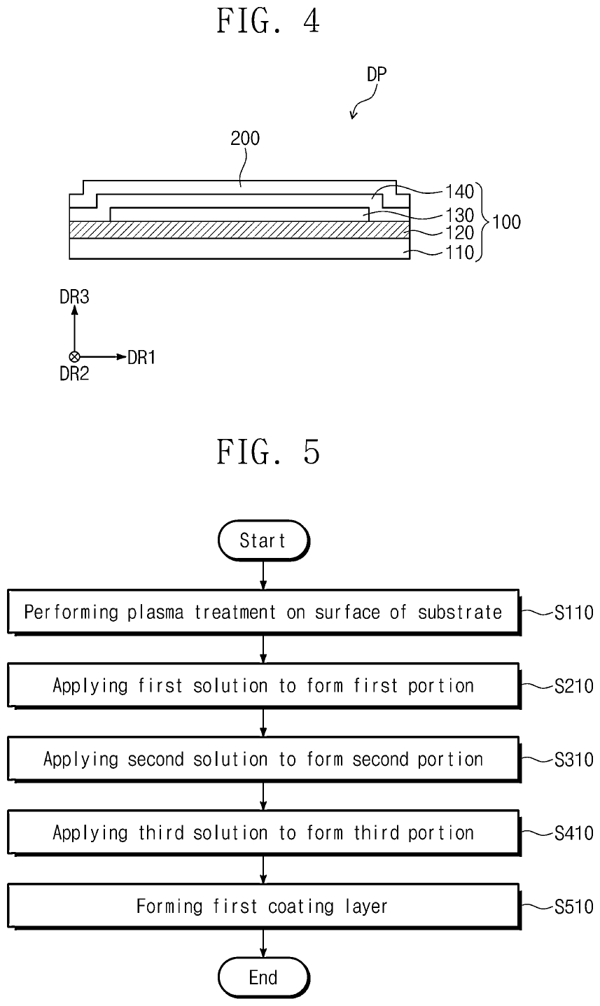

FIG. 3 is a cross-sectional view of a display device and a camera module taken along line I-I′ in FIG. 2 according to an embodiment of the disclosure, and FIG. 4 is a cross-sectional view showing a display panel according to an embodiment of the disclosure.

Referring to FIGS. 3 and 4, an embodiment of the display device DD may include the window WIN and the display module DM (see FIG. 1A).

The window WIN may be disposed on the display panel DP. The window WIN may overlap the display area DP-DA (see FIG. 2) of the display panel DP and provide an optically transparent area. The window WIN may provide the display surface DS (see FIG. 1A) of the electronic device 1000. The image IM (see FIG. 1A) displayed on the display panel DP may be viewed by the user via the window WIN.

The window WIN may include a thin glass or a synthetic resin film. In an embodiment where the window WIN includes the thin glass, a thickness of the window WIN may be equal to or smaller than about 100 micrometers (μm), and may be, for example, about 60 μm, but the thickness of the window WIN is not limited thereto. In an embodiment, where the window WIN includes the synthetic resin film, the window WIN may include a polyimide (PI) film or a polyethylene terephthalate (PET) film.

The window WIN may include or be made of a soft or flexible material. Accordingly, the window WIN may be folded or unfolded around the folding axis FX (see FIG. 1B). That is, when a shape of the display panel DP changes, a shape of the window WIN may also change corresponding to the shape of the display panel DP.

The window WIN may transmit the image IM (see FIG. 1A) from the display panel DP therethrough and at the same time alleviate an external impact, thereby effectively preventing the display panel DP from being damaged or malfunctioning because of the external impact. The external impact may be a force from the outside that may be expressed as a pressure, a stress, or the like., and may mean any type of force that may cause defects in the display panel DP.

The display module DM (see FIG. 1A) may include the display panel DP, an optical layer OPL, a support plate 300, a panel protection film PFL, a lower protection film CPL, a first cushion layer CS1, a second cushion layer CS2, a first plate 400, and a second plate 500, and may further include various other functional layers.

The display panel DP may be a flexible panel. in an embodiment, as shown in FIG. 4, the display panel DP may include a display layer 100 and a sensor layer 200. This will be described later. The display panel DP may have a thickness of about 40 μm.

The display layer 100 according to an embodiment of the disclosure may be a light emitting display layer, and may not be particularly limited. In an embodiment, for example, the display layer 100 may include an organic light emitting display layer, a quantum dot display layer, a micro light emitting diode (LED) display layer, a nano LED display layer, or the like. A light emitting layer of the organic light emitting display layer may include an organic light emitting material. A light emitting layer of the quantum dot display layer may include a quantum dot, a quantum rod, or the like. A light emitting layer of the micro LED display layer may include a micro LED. A light emitting layer of the nano LED display layer may include a nano-LED.

The display layer 100 may include a base layer 110, a circuit layer 120, a light emitting element layer 130, and an encapsulation layer 140.

The base layer 110 may be a member that provides a surface on which the circuit layer 120 is disposed. The base layer 110 may be a glass substrate, a metal substrate, or a polymer substrate. However, the embodiment may not be limited thereto, and the base layer 110 may be an inorganic layer, an organic layer, or a composite material layer.

The base layer 110 may have a multi-layer structure. In an embodiment, for example, the base layer 110 may include a first synthetic resin layer, a silicon oxide (SiOx) layer disposed on the first synthetic resin layer, an amorphous silicon (a-Si) layer disposed on the silicon oxide layer, and a second synthetic resin layer disposed on the amorphous silicon layer. The silicon oxide layer and the amorphous silicon layer may be referred to as a base barrier layer.

Each of the first and second synthetic resin layers may contain a polyimide-based resin. In addition, each of the first and second synthetic resin layers may include at least one selected from an acrylate-based resin, a methacrylate-based resin, a polyisoprene-based resin, a vinyl-based resin, an epoxy-based resin, a urethane-based resin, a cellulose-based resin, a siloxane-based resin, a polyamide-based resin, and a perylene-based resin. Herein, a “˜˜”-based resin means containing a functional group of “˜˜”.

The circuit layer 120 may be disposed on the base layer 110. The circuit layer 120 may include an insulating layer, a semiconductor pattern, a conductive pattern, a signal line, or the like. The insulating layer, a semiconductor layer, and a conductive layer may be formed on the base layer 110 using a method such as coating or deposition, and thereafter, the insulating layer, the semiconductor layer, and the conductive layer may be selectively patterned via a plurality of photolithography processes, such that the semiconductor pattern, the conductive pattern, and the signal line included in the circuit layer 120 may be formed.

The light emitting element layer 130 may be disposed on the circuit layer 120. The light emitting element layer 130 may include a light emitting element. In an embodiment, for example, the light emitting element layer 130 may include an organic light emitting material, a quantum dot, a quantum rod, a micro LED, or a nano LED.

The encapsulation layer 140 may be disposed on the light emitting element layer 130. The encapsulation layer 140 may protect the light emitting element layer 130 from foreign substances such as moisture, oxygen, and dust particles.

The sensor layer 200 may be formed on the display layer 100 via a subsequent process. In this case, it may be expressed that the sensor layer 200 is directly disposed on the display layer 100. Being directly disposed may mean that a third component is not disposed between the sensor layer 200 and the display layer 100. That is, a separate adhesive member may not be disposed between the sensor layer 200 and the display layer 100. Alternatively, the sensor layer 200 may be coupled to the display layer 100 via the adhesive member. The adhesive member may include a conventional adhesive.

The optical layer OPL may be disposed on the display panel DP. The optical layer OPL may reduce reflectance of external light. The optical layer OPL may include a stretchable synthetic resin film. In an embodiment, for example, the optical layer OPL may be provided by dyeing a polyvinyl alcohol (PVA) film with an iodine compound. Alternatively, the optical layer OPL may include a color filter. The optical layer OPL may include various layers as long as they may reduce the reflectance of external light, and may not be limited to one embodiment.

The optical layer OPL and the window WIN may be coupled to each other by a predetermined adhesive layer AD1. The adhesive layer AD1 may include an optical clear adhesive (OCA), an optical clear resin (OCR), or a pressure sensitive adhesive (PSA). Adhesive layers to be described below may include a same material as the adhesive layer AD1 and may include a conventional adhesive. In an embodiment, for example, the adhesive layer AD1 may have a thickness of about 50 μm.

The support plate 300 may be disposed under the display panel DP. The support plate 300 may support the display panel DP. The support plate 300 may include a first support 310, a second support 320, and a foldable portion 330. The first support 310 and the second support 320 may be spaced apart from each other in the first direction DR1 with the foldable portion 330 interposed therebetween. A thickness of the support plate 300 may be greater than a thickness of the display panel DP. In an embodiment, for example, the thickness of the support plate 300 may be about 150 μm.

When viewed in a plan view, the first support 310 may overlap the first non-foldable area NFA1.

When viewed in a plan view, the second support 320 may overlap the second non-foldable area NFA2.

Each of the first support 310 and the second support 320 may have insulating properties. In an embodiment, for example, each of the first support 310 and the second support 320 may include or be made of plastic or glass.

The foldable portion 330 may overlap the foldable area FA. A plurality of openings HA may be defined through the foldable portion 330. The plurality of openings HA may be spaced apart from each other in the first direction DR1. Accordingly, the foldable portion 330 may have a lattice shape when viewed in a plan view. As a size of each of the plurality of openings HA changes, a shape of the support plate 300 in the foldable area FA may easily change. In an embodiment, for example, although not shown, a material having high ductility may be filled in the plurality of openings HA.

When folded, the foldable portion 330 may easily change in a shape because of the plurality of openings HA. The foldable portion 330 may include or be formed of a same material as the first support 310 and the second support 320. However, this is an example, and the foldable portion 330 according to an embodiment of the disclosure may include a material different from that of the first support 310 and the second support 320. In an embodiment, for example, the foldable portion 330 may include a single metal or an alloy. Accordingly, the foldable portion 330 may stably protect the foldable area of the display panel DP even in the folded state.

The panel protection film PFL and the lower protection film CPL may be disposed between the display panel DP and the support plate 300.

The panel protection film PFL may be disposed under the display panel DP. The panel protection film PFL may protect a lower portion of the display panel DP. The panel protection film PFL may contain a flexible plastic material. In an embodiment, for example, the panel protection film PFL may include polyethylene terephthalate (PET). The panel protection film PFL may have a thickness greater than that of the display panel DP. In an embodiment, for example, the panel protection film PFL may have the thickness of about 68 μm.

The lower protection film CPL may be disposed under the panel protection film PFL. The lower protection film CPL may have a predetermined color. The lower protection film CPL may protect a rear surface of the display panel DP and may prevent a problem that the rear surface of the display panel DP is visible by light. The lower protection film CPL may include or be made of a material having a great light absorption rate.

In an embodiment, for example, a predetermined recession CPL_G overlapping the foldable area FA may be defined in the lower protection film CPL. The recession CPL_G may reduce a folding stress by reducing a thickness of the lower protection film CPL in the foldable area FA. In addition, a force of bonding with the support plate 300 may be improved by further adding an adhesive layer to the recession CPL_G.

The first plate 400 may be disposed under the support plate 300. The first plate 400 may support the display panel DP. When viewed in a plan view, the first plate 400 may overlap the second non-foldable area NFA2.

The first plate 400 and the second plate 500 may face each other. The first plate 400 and the second plate 500 may be spaced apart from each other in the first direction DR1. When viewed in a plan view, the first plate 400 and the second plate 500 may not overlap each other.

The first plate 400 may have a greater modulus than the support plate 300. Accordingly, the first plate 400 may stably protect the display panel DP from the external impact. In an embodiment, for example, the first plate 400 may include aluminum alloy, carbon fiber reinforced plastic, or the like.

The first cushion layer CS1 and an insulating layer TP may be disposed under the first plate 400. When viewed in a plan view, the first cushion layer CS1 may overlap the first plate 400.

The first cushion layer CS1 may protect the display panel DP by absorbing the external impact. The first cushion layer CS1 may include a foam sheet having a predetermined elasticity. The first cushion layer CS1 may include sponge or polyurethane.

The insulating layer TP may be disposed under the first cushion layer CS1. The insulating layer TP may include an insulating film. The insulating layer TP may effectively prevent an inflow of static electricity.

The second plate 500 may be disposed under the support plate 300. The second plate 500 may support the display panel DP. When viewed in a plan view, the second plate 500 may overlap the first non-foldable area NFA1.

The second plate 500 may have a greater modulus than the support plate 300. Accordingly, the second plate 500 may stably protect the display panel DP from the external impact. In an embodiment, for example, the second plate 500 may contain aluminum alloy, carbon fiber reinforced plastic, or the like.

The second cushion layer CS2 and the insulating layer TP may be disposed under the second plate 500. When viewed beneath, the second cushion layer CS2 may overlap the second plate 500.

The second cushion layer CS2 may protect the display panel DP by absorbing the external impact. The second cushion layer CS2 may include a foam sheet having a predetermined elasticity. The second cushion layer CS2 may include sponge or polyurethane.

The insulating layer TP may be disposed under the second cushion layer CS2. The insulating layer TP may include the insulating film. The insulating layer TP may effectively prevent the inflow of the static electricity.

In the sensor area UA, a through-hole HAA may be defined through the support plate 300, the panel protection film PFL, the lower protection film CPL, the first cushion layer CS1, the second cushion layer CS2, the first plate 400, and the second plate 500 in the third direction DR3.

The camera module CMM may be disposed under the through-hole HAA. The camera module CMM may capture an external image by receiving natural light via the through-hole HAA.

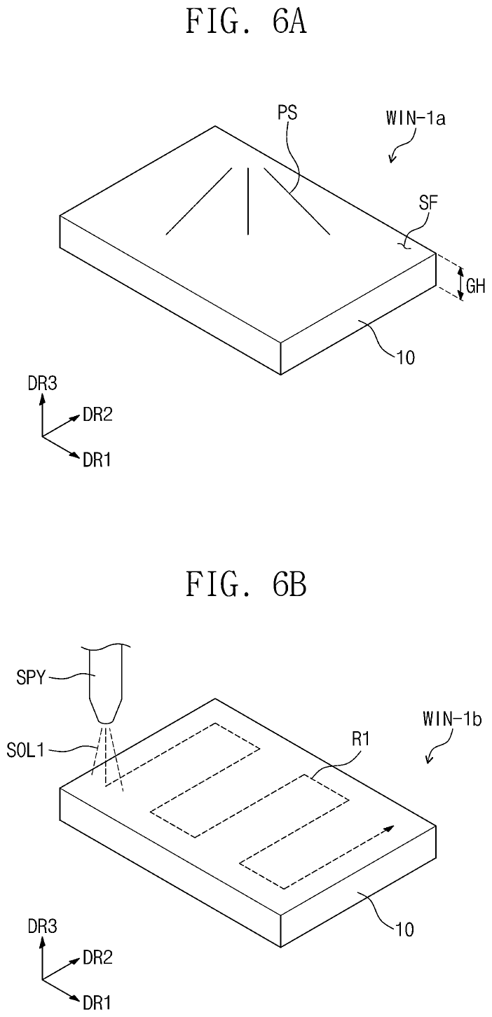

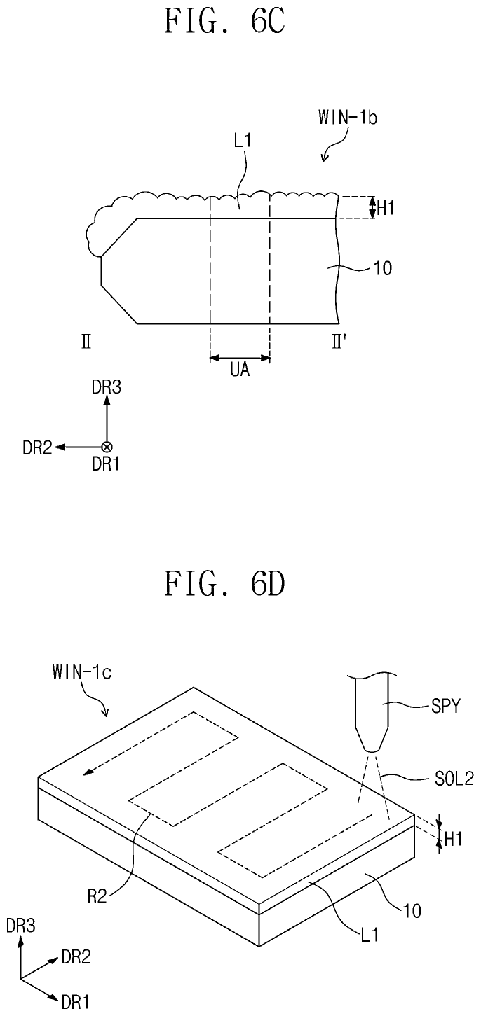

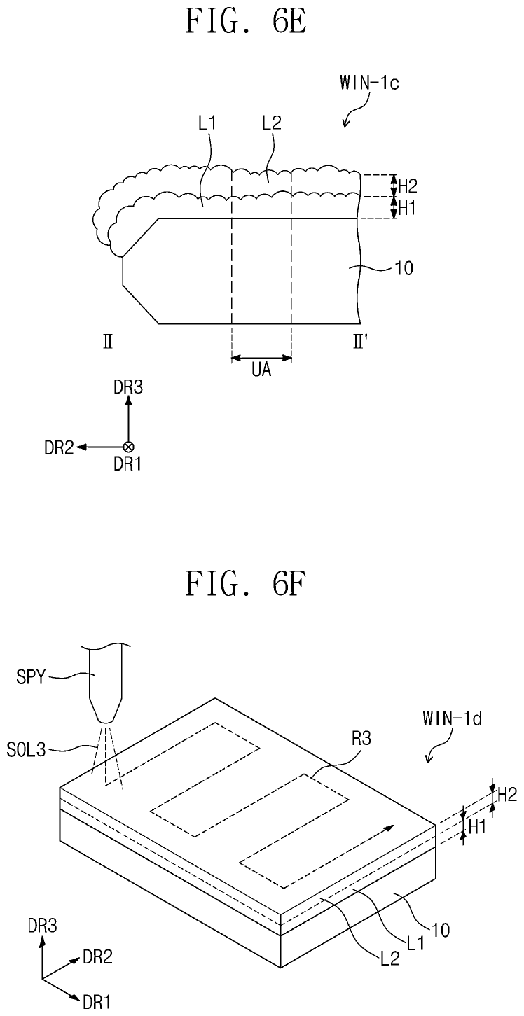

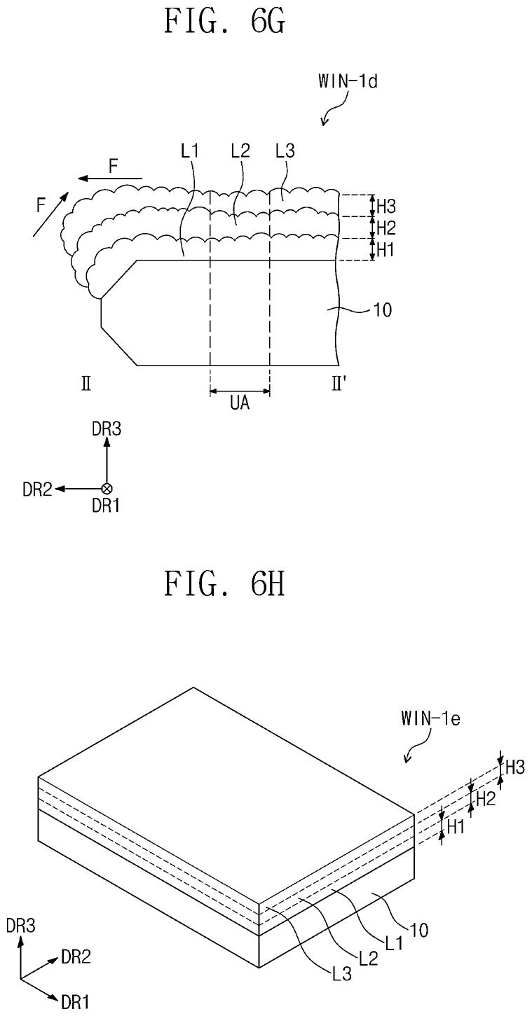

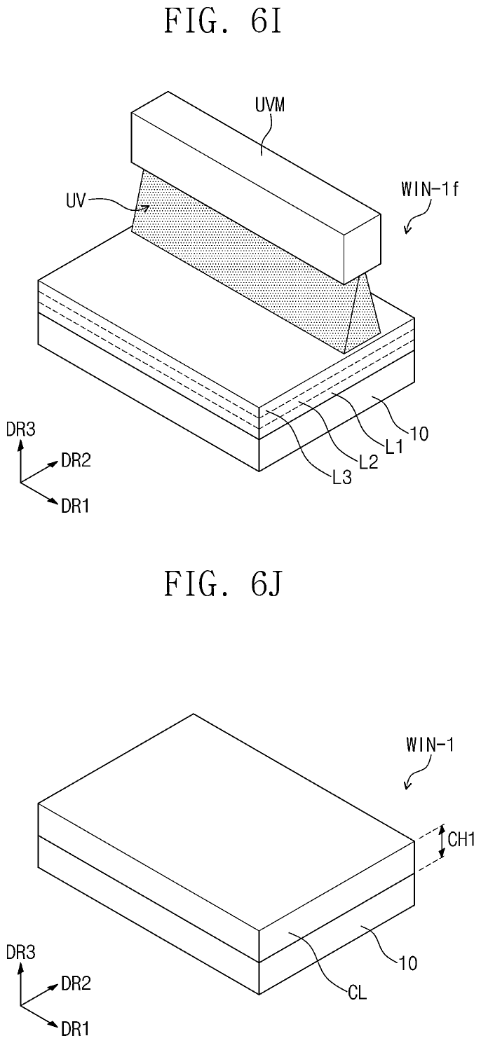

FIG. 5 is a flowchart illustrating a window manufacturing method according to an embodiment of the disclosure, and FIG. 6A is a perspective view showing a process of a window manufacturing method according to an embodiment of the disclosure.

Referring to FIGS. 5 and 6A, an embodiment of a method for manufacturing the window WIN (see FIG. 3) may include performing a plasma treatment on a surface of a substrate 10 (S110), applying a first solution to form a first portion (S210), applying a second solution to form a second portion (S310), applying a third solution to form a third portion (S410), and forming a first coating layer (S510). This will be described later.

FIG. 6A shows the process of performing the plasma treatment on the surface of the substrate 10 (S110).

A preliminary window WIN-la may include the substrate 10. The substrate 10 may include thin glass, plastic, or a synthetic resin film. In an embodiment, for example, the substrate 10 may include ultra-thin glass (UTG).

The substrate 10 may have a thickness GH in the third direction DR3. The thickness GH of the substrate 10 may be equal to or smaller than about 100 μm. In an embodiment, for example, the thickness GH of the substrate 10 may be about 30 μm. In such an embodiment, because the thickness GH of the substrate 10 is smaller than a thickness of 0.5 millimeter (mm) or about 500 μm, which is a thickness of an existing or conventional rigid cover glass, when folding the window WIN (see FIG. 3), stress generated in the foldable area is reduced, so that the window WIN may be folded flexibly.

Plasma PS may be provided to the preliminary window WIN-la for the plasma treatment. The plasma PS may pre-treat a surface SF of the substrate 10. The plasma PS may modify the surface of the substrate 10 to improve a force of bonding between the surface SF of the substrate 10 and a solution to be provided later. Because of the plasma PS treatment, the surface SF of the substrate 10 may generate a polar surface containing a hydrophilic functional group.

The plasma PS may clean the substrate 10.

According to an embodiment of the disclosure, the process of performing the plasma treatment on the surface of the substrate 10 (S110) may be a pretreatment process for easily forming the coating layer on the substrate 10. The pretreated substrate 10 may easily proceed to the next operation of the manufacturing method. Therefore, the method for manufacturing the window with improved reliability may be provided.

FIG. 6B is a perspective view showing a process of a window manufacturing method according to an embodiment of the disclosure, and FIG. 6C is a cross-sectional view of a preliminary window cut along a line corresponding to II-II′ in FIG. 1A according to an embodiment of the disclosure. FIG. 6B shows the process of forming the first portion by applying the first solution.

Referring to FIGS. 5, 6B, and 6C, a first solution SOLI may be applied to a preliminary window WIN-1b. The first solution SOLI may be applied onto the substrate 10, and a first portion L1 may be formed (S210). The process of forming the first portion L1 (S210) may be referred to as the first application operation (S210).

The first solution SOL1 may be applied to improve impact resistance of the substrate 10 and to prevent the substrate 10 from being shattered or scattered when the substrate 10 is damaged. The first solution SOL1 may include at least one selected from a siloxane-based resin, a urethane-based resin, an epoxy-based resin, a polyester-based resin, a polyether-based resin, an acrylate-based resin, an acrylonitrile-butadiene-styrene (ABS) resin, and rubber.

The first solution SOL1 may have a viscosity in a range from about 6 centipoise (cps) to about 10 cps. If the viscosity of the first solution (SOL1) exceeds 10 cps, leveling of the first solution SOLI disposed on the substrate 10 is difficult, and it may be difficult to use a spray coating method.

The first solution SOL1 may include an ultraviolet (UV)-curable solvent-free material, a UV-curable solvent material, a heat-curable material, or the like.

The first solution SOLI may be applied by the spray coating method. A spray nozzle SPY may apply the first solution SOLI to the surface SF (see FIG. 6A) of the substrate 10. In the first application operation (S210), the first solution SOL1 applied onto the substrate 10 may be provided in a capacity of about 2.7 cubic centimeters (cc). However, this is an example, and the capacity of the first solution SOL1 according to an embodiment of the disclosure is not limited thereto. The first solution SOL1 may be provided in the capacity based on a thickness H1 of the first portion L1.

The first solution SOLI may be applied along a path in a zigzag shape along (or toward) the first direction DR1. In an embodiment, for example, the first solution SOLI may be applied in a ‘ [symbol] ’ shape along the first direction DR1. The first solution SOLI may be applied onto the substrate 10 along a first path R1.

The first solution SOL1 applied onto the substrate 10 may be formed into the first portion L1. The first portion L1 may be liquid.

The first portion L1 may be formed with the first thickness H1. The first thickness H1 may be in a range from about 6.7 μm to about 10 μm.

An edge bead phenomenon may occur at an edge of the substrate 10. The edge bead phenomenon may be caused by an interfacial tension between the substrate 10 and the solution applied onto the substrate 10. The edge bead phenomenon may refer to a phenomenon in which the solution applied onto the substrate 10 is agglomerated. The sensor area UA may be referred to as an area away from an edge of the window WIN by a distance from about 2.8 mm to about 6.3 mm.

It may be defined that the edge bead phenomenon is reduced or eliminated when a peak-to-valley (PV) value, which is a difference between a maximum value and a minimum value (peak to valley) of a wavefront aberration of a coating layer CL (see FIG. 6I) in the sensor area UA of the disclosure, is equal to or greater than 0.2 wavelength and equal to or smaller than 0.92 wavelength. It may be defined that the edge bead phenomenon has occurred when the PV value exceeds 0.92 wavelength.

The wavefront aberration is a value representing a degree of distortion of a wavefront when light passes through an optical system, which is a measuring object. The PV value may indicate optical flatness. The PV value may be proportional to the difference between the maximum value and the minimum value of a physical thickness (the peak to valley). The PV value may be used for evaluation of the coating layer CL (see FIG. 6I).

In a case where a surface of the sensor area UA may be non-uniform because of the edge bead phenomenon, which may cause light received by the camera module CMM to be refracted and a resolution of the camera module CMM to be reduced. According to an embodiment of the disclosure, the edge bead phenomenon may be reduced or eliminated because of the small thickness of the first portion L1. The first portion L1 may be applied with a uniform top surface. The window WIN (see FIG. 2) may be applied with the coating layer for improving the impact resistance of the substrate 10 a plurality of times. The first portion L1 having the uniform top surface may be formed in the sensor area UA such that optical characteristics of the sensor area UA may be improved. Therefore, the window WIN (see FIG. 2) with improved impact resistance and flatness and the method for manufacturing the window may be provided.

FIG. 6D is a perspective view showing a process of a window manufacturing method according to an embodiment of the disclosure, and FIG. 6E is a cross-sectional view of a preliminary window cut along a line corresponding to II-II′ in FIG. 1A according to an embodiment of the disclosure. FIG. 6D shows the process of forming the second portion by applying the second solution.

Referring to FIGS. 5, 6D, and 6E, a second solution SOL2 may be applied to the preliminary window WIN-1b. The second solution SOL2 may be applied onto the first portion L1, and a second portion L2 may be formed (S310). The process of forming the second portion L2 (S310) may be referred to as the second application operation (S310).

The second solution SOL2 may be substantially the same as the first solution SOL1.

The second solution SOL2 may be applied by the spray coating method. The spray nozzle SPY may apply the second solution SOL2 onto the first portion L1. In the second application operation (S310), the second solution SOL2 applied onto the first portion L1 may be provided in a capacity of about 2.7 cc.

The second solution SOL2 may be applied along a path in a zigzag shape along a direction opposite to the first direction DR1. In an embodiment, for example, the second solution SOL2 may be applied in a ‘ [symbol] ’ shape along the direction opposite to the first direction DR1. The second solution SOL2 may be applied onto the first portion L1 along a second path R2. The second path R2 may be different from the first path R1 (see FIG. 5B) only in a direction and may have a same shape.

The second solution SOL2 applied onto the first portion L1 may be formed into the second portion L2. The second portion L2 may be a liquid.

The second portion L2 may be formed to have a second thickness H2. The second thickness H2 may be in a range from about 6.7 μm to about 10 μm. The second thickness H2 may be substantially the same as the first thickness H1.

According to an embodiment of the disclosure, because the second portion L2 includes or is made of a same material as the first portion L1, an interfacial tension between the first portion L1 and the second portion L2 may be reduced or eliminated. Accordingly, in such an embodiment, the edge bead phenomenon may be reduced or eliminated. The second portion L2 may be applied with a uniform top surface. In the window WIN (see FIG. 2) according to an embodiment of the disclosure, the coating layer for improving the impact resistance of the substrate 10 may be applied a plurality of times. The second portion L2 having the uniform top surface may be formed in the sensor area UA such that the optical characteristics of the sensor area UA may be improved. Therefore, the window WIN (see FIG. 2) with the improved impact resistance and flatness may be provided.

FIG. 6F is a perspective view showing a process of a window manufacturing method according to an embodiment of the disclosure, FIG. 6G is a cross-sectional view of a preliminary window cut along a line corresponding to II-II′ in FIG. 1A according to an embodiment of the disclosure, and FIG. 6H is a perspective view showing a process of a window manufacturing method according to an embodiment of the disclosure.

Referring to FIGS. 5 and 6F to 6H, a third solution SOL3 may be applied to a preliminary window WIN-1d. The third solution SOL3 may be applied onto the second portion L2, and a third portion L3 may be formed (S410). The process of forming the third portion L3 (S410) may be referred to as a third application operation.

The third solution SOL3 may be substantially the same as the first solution SOLI and the second solution SOL2.

The third solution SOL3 may be applied by the spray coating method. The spray nozzle SPY may apply the third solution SOL3 onto the second portion L2. In the third application operation (S410), the third solution SOL3 applied onto the second portion L2 may be provided in a capacity of 2.7 cc.

The third solution SOL3 may be applied along a path in a zigzag shape along the first direction DR1. In an embodiment, for example, the third solution SOL3 may be applied in a ‘ [symbol] ’ shape along the first direction DR1. The third solution SOL3 may be applied onto the second portion L2 along a third path R3. The third path R3 may be substantially the same as the first path R1 (see FIG. 5B).

According to an embodiment of the disclosure, the coating layer applied onto the substrate 10 may applied a plurality of times. In odd-numbered applications, the coating layer may be applied along the first path R1, and in even-numbered applications, the coating layer may be applied along the second path R2. The spray nozzle SPY may perform the plurality of application processes with minimal movement. Therefore, the method for manufacturing the window with the improved reliability may be provided.

The third solution SOL3 applied onto the second portion L2 may be formed into the third portion L3. The third portion L3 may be a liquid.

The third portion L3 may be formed with a third thickness H3. The third thickness H3 may be in a range from about 6.7 μm to about 10 μm. The third thickness H3 may be substantially a same as the second thickness H2.

The edge bead phenomenon may be proportional to an interfacial tension (F) between the substrate 10 and the solution applied onto the substrate 10. The interfacial tension (F) may be calculated based on Mathematical Formula 1 below.

$${γ}_{SL} = {γ}_{S} + {γ}_{L} - 2 ( \sqrt{{γ}_{S}^{D} \cdot {γ}_{L}^{D}} + \sqrt{{γ}_{S}^{P} \cdot {γ}_{L}^{P}} ) \qquad [ Mathematical Formula 1 ]$$

An interfacial tension between a first material and a second material in Mathematical Formula 1 is denoted by γ_{SL}. A surface tension of the first material is denoted by γ_{S}. A surface tension of a polar portion of the first material is denoted by γ_{S}^{P}. A surface tension of a non-polar portion of the first material is denoted by γ_{S}^{D}. A surface tension of the second material is denoted by γ_{L}. A surface tension of a polar portion of the second material is denoted by γ_{L}^{P}. A surface tension of a non-polar portion of the second material is denoted by γ_{L}^{D}. The surface tension and the interfacial tension may have units of millinewton per meter (mN/m). In this regard, the first material may be a solid and the second material may be a liquid.

TABLE 1

| | Non-polar portion | Polar portion | Sum |
|---|---|---|---|
| Substrate | 34.3 | 38.4 | 72.7 |
| Existing coating | 16.9 | 2.1 | 19.0 |
| solution | | | |

| | |
|---|---|
| Interfacial tension | 25.6 |

Table 1 shows surface tensions of the substrate and the existing (conventional) coating solution, respectively, and an interfacial tension between the substrate and the existing coating solution calculated using Mathematical Formula 1 above. In this regard, the existing coating solution may be a solution used in an existing process of forming the coating layer with one application. A contact angle between the substrate and the existing coating solution may be 50.3°. The smaller the contact angle, the smaller the PV value of the coating layer, and the occurrence of the edge bead phenomenon may be reduced or eliminated. The contact angle may be calculated based on the Mathematical Formula 2 below.

$$cos θ = \frac{{γ}_{SV} - {γ}_{SL}}{{γ}_{VL}} \qquad [ Mathematical Formula 2 ]$$

In Mathematical Formula 2, the contact angle is denoted by θ. An interfacial tension between the first material and the outside (air) is denoted by γ_{SV}. An interfacial tension between the second material and the outside (air) is denoted by γ_{LV}. An interfacial tension between the first material and the second material is denoted by γ_{SL}.

In this regard, γ_{SV} and γ_{LV} may be fixed values, and the contact angle may be proportional to the interfacial tension between the first material and the second material.

TABLE 2

| | Non-polar | | |
|---|---|---|---|
| | portion | Polar portion | Sum |
| First portion | 16.9 | 20 | 36.9 |
| Second portion and | 16.9 | 2.1 | 19.0 |
| third portion | | | |

| | |
|---|---|
| Interfacial tension F | 9.1 |

Table 2 shows a surface tension of the first portion L1, a surface tension up to the third portion L3, and the interfacial tension (F) between the first portion L1, the second portion L2, and the third portion L3 calculated using Mathematical Formula 1 above. A contact angle between the first portion L1 and the second portion L2 or the third portion L3 may be 10.2°. Referring to Table 1, in a case where the coating layer is formed on the substrate 10 at once, the interfacial tension may be relatively great. In this case, the edge bead phenomenon may occur. Because of the edge bead phenomenon, the surface of the sensor area UA may be non-uniform, and as a result, light received by the camera module CMM may be refracted and the resolution of the camera module CMM may be reduced. According to an embodiment of the disclosure, referring to Table 2, the first portion L1 may be affected by a polarity of the substrate 10, so that the surface tension of the polar portion may increase. The interfacial tension F between the first portion L1, the second portion L2, and the third portion L3 may be relatively small. Accordingly, the edge bead phenomenon may be reduced. The third portion L3 may be applied with a uniform top surface. In an embodiment, the coating layer may be applied a plurality of times to improve the impact resistance of the substrate 10. The third portion L3 with the uniform top surface may be formed in the sensor area UA such that the optical characteristics of the sensor area UA may be improved. Therefore, the window WIN (see FIG. 2) with the improved impact resistance and flatness and the method for manufacturing the window may be provided.

A preliminary window WIN-1e in which the application processes are completed may have a shape in which the first portion L1, the second portion L2, and the third portion L3 are sequentially stacked on the substrate 10.

The thickness H1 of the first portion L1, the thickness H2 of the second portion L2, and the thickness H3 of the third portion L3 may be substantially the same as each other.

The number of times of processes S210, S310, and S410 of forming the plurality of portions L1, L2, and L3 to form the coating layer CL (see FIG. 6J) may be limited to three. If the number of times the solution is applied is equal to or smaller than two, the edge bead phenomenon may occur, and if the number of times the solution is applied is equal to or greater than four, an appearance quality of the window WIN (see FIG. 2) may deteriorate and productivity may decrease.

FIG. 6I is a perspective view showing a process of a window manufacturing method according to an embodiment of the disclosure, and FIG. 6J is a perspective view showing a window according to an embodiment of the disclosure.

Referring to FIGS. 5, 6I, and 6J, the coating layer CL may be formed in a preliminary window WIN-1f (S510). The process of forming the coating layer CL (S510) may be referred to as the forming of the coating layer (S510).

In the forming of the coating layer (S510), a curing module UVM may be disposed on the preliminary window WIN-1f. The curing module UVM may radiate an ultraviolet ray UV to the preliminary window WIN-1f. The curing module UVM may move along the second direction DR2. The ultraviolet ray UV may have a wavelength in a range from about 200 nanometers (nm) to about 400 nm.

In the forming of the coating layer (S510), the first portion L1, the second portion L2, and the third portion L3 may be simultaneously cured by the ultraviolet ray UV radiated thereto. In this regard, the forming of the coating layer CL by applying the solution the plurality of times, such as the first portion L1, the second portion L2, and the third portion L3, and then curing them at once may be referred to as a multi-stage coating method.

However, this is an example, and the curing method according to an embodiment of the disclosure is not limited to the ultraviolet curing. In an embodiment, for example, the curing method may include thermal curing, electron beam curing, or the like.

The cured first portion L1, second portion L2, and third portion L3 may be solids. The cured first portion L1, second portion L2, and third portion L3 may be referred to as the coating layer CL. That is, the coating layer CL may be a solid layer.

A window WIN-1 may be manufactured by the window manufacturing method. The window WIN-1 may include the substrate 10 and the coating layer CL. The coating layer CL may be disposed on the substrate 10. The coating layer CL may improve the impact resistance of the substrate 10 and effectively prevent the substrate from being shattered or scattered when the substrate 10 is damaged.

The coating layer CL may have a predetermined thickness CH. In an embodiment, the thickness CH may be in a range from about 20 μm to about 30 μm. If the thickness CH is smaller than about 20 μm, even when the multi-stage coating method is not used, it may be controlled such that the edge bead phenomenon does not occur at the sensor area UA with one solution application, and if the thickness CH is greater than 30 μm, the edge bead phenomenon may occur even when the multi-stage coating method is used. This will be described later.

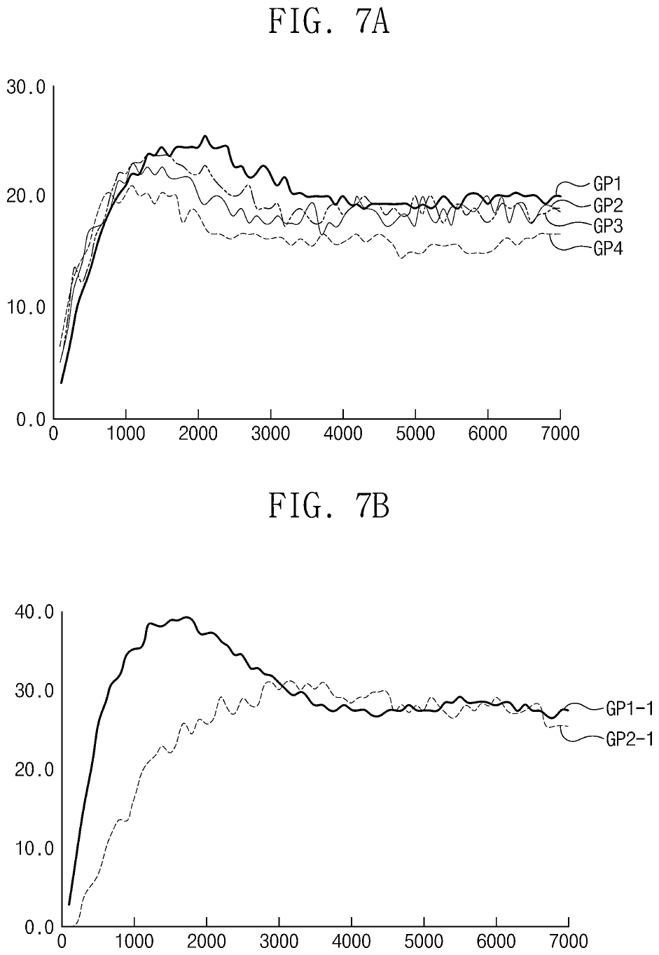

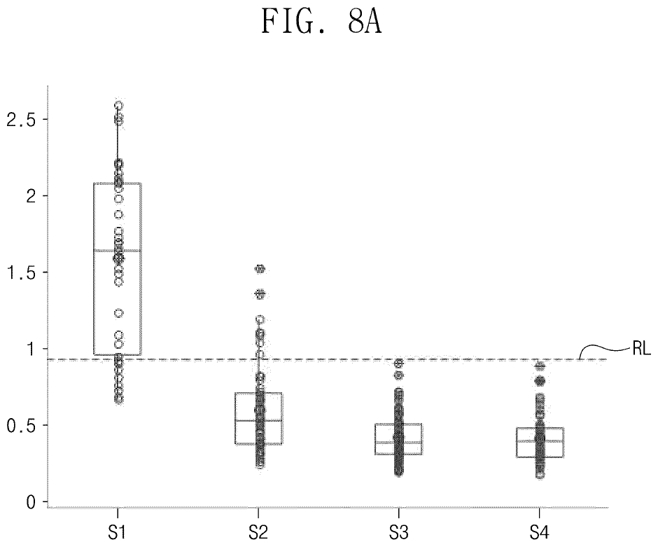

FIG. 7A is a graph showing a thickness of the coating layer based on a distance from an edge of a substrate according to an embodiment of the disclosure.

Referring to FIGS. 6J and 7A, first to fourth graphs GP1, GP2, GP3, and GP4 show the thickness CH measured when the thickness CH of the coating layer CL is about 20 μm. In FIG. 7A, a horizontal axis represents a distance from an edge of the substrate 10 in units of um, and a vertical axis represents the thickness CH in units of μm.

The first graph GP1 shows the thickness CH of the coating layer CL formed with a single application process.

The second graph GP2 shows the thickness CH of the coating layer CL formed with two application processes.

The third graph GP3 shows the thickness CH of the coating layer CL formed with three application processes. That is, the third graph GP3 may show the coating layer CL formed via the multi-stage coating according to an embodiment of the disclosure.

The fourth graph GP4 shows the thickness CH of the coating layer CL formed with four application processes.

A peak value by the interfacial tension may be smaller at the coating layer CL formed via the multi-stage coating than at the coating layer CL formed with the single application process.

According to an embodiment of the disclosure, the difference between the maximum value and the minimum value (the peak to valley) of the wavefront aberration of the coating layer CL in the sensor area UA may be smaller at the coating layer CL formed via the multi-stage coating than at the coating layer CL formed with the single application process. In such an embodiment, the edge bead phenomenon may be reduced or eliminated in the coating layer CL such that the optical characteristics of the sensor area UA may be improved. Therefore, the window WIN-1 with the improved impact resistance and flatness may be provided.

FIG. 7B is a graph showing a thickness of the coating layer based on a distance from an edge of a substrate according to an embodiment of the disclosure.

Referring to FIGS. 6J and 7B, a first graph GP1-1 and a second graph GP2-1 show the thickness CH measured when the thickness CH of the coating layer CL is about 30 μm. In FIG. 7B, a horizontal axis represents the distance from the edge of the substrate 10 in units of μm, and a vertical axis represents the thickness CH in units of μm.

The first graph GP1-1 shows the thickness CH of the coating layer CL formed with the single application process.

The second graph GP2-1 shows the thickness CH of the coating layer CL formed with the three application processes. That is, the second graph GP2-1 may show the coating layer CL formed via the multi-stage coating according to an embodiment of the disclosure.

The peak value by the interfacial tension may be smaller at the coating layer CL formed via the multi-stage coating than at the coating layer CL formed with the single application process.

According to an embodiment of the disclosure, the difference between the maximum value and the minimum value (the peak to valley) of the wavefront aberration of the coating layer CL in the sensor area UA may be smaller at the coating layer CL formed via the multi-stage coating than at the coating layer CL formed with the single application process. In such an embodiment, the edge bead phenomenon may be reduced or eliminated in the coating layer CL such that the optical characteristics of the sensor area UA may be improved. Therefore, the window WIN-1 with the improved impact resistance and flatness may be provided.

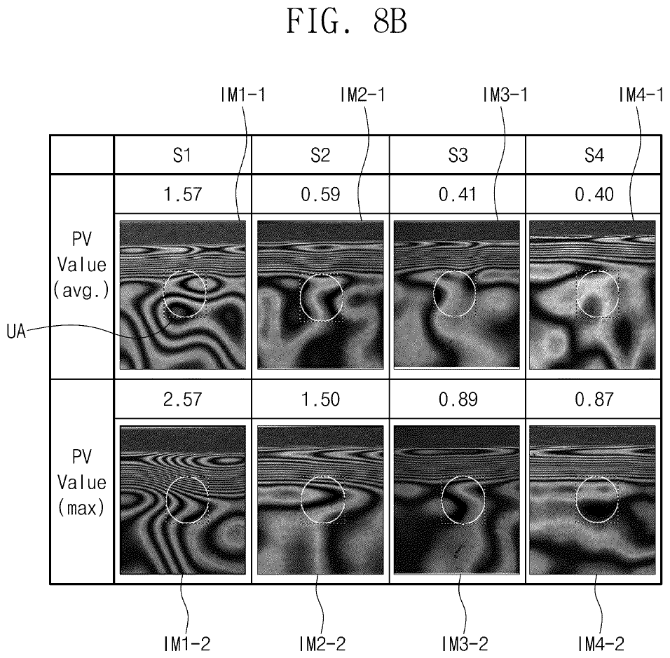

FIG. 8A is a box graph showing a PV value based on the number of times of application according to an embodiment of the disclosure, and FIG. 8B shows captured images of a window based on the number of times of application according to an embodiment of the disclosure.

Referring to FIGS. 6J, 8A, and 8B, the PV value may be an index indicating the optical flatness. In FIG. 8A, a horizontal axis shows the number of applications, and a vertical axis shows the PV value. The PV value shows 0 wavelength to 2.5 wavelength as an example. In this regard, 1 wavelength may be about 632.8 nm. FIG. 8A shows each PV value measured for each number of times of application when the thickness CH of the coating layer CL is about 20 μm as an example.

Each of images IM1-1 to IM4-2 obtained by capturing the window WIN-1 shows the thickness CH via a level curve.

An average value of the PV values in the coating layer formed with a single application process S1 may be 1.57 wavelength, and a maximum value of the PV values may be 2.57 wavelength. The coating layer formed with the single application process S1 may be referred to as an existing (or conventional) coating layer.

The image IM1-1 and the first-second image IM1-2 may be images obtained by capturing the window including the coating layer formed with the single application process S1.

The image IM1-1 may be an image obtained by capturing a top surface of a window having the average value of the PV values. For example, the first-first image IM1-1 may be an image obtained by capturing a top surface of a window having the PV value of 1.57 wavelength.

The image IM1-2 may be an image obtained by capturing a top surface of a window having the maximum value of the PV values. For example, the first-second image IM1-2 may be an image obtained by capturing a top surface of a window having the PV value of 2.57 wavelength.

An average value of the PV values in the coating layer formed with two application processes S2 may be 0.59 wavelength, and a maximum value of the PV values may be 1.50 wavelength. In this regard, a difference from the average value of the PV values in the single application process S1 may be 0.98 wavelength.

The second-first image IM2-1 and the second-second image IM2-2 may be images obtained by capturing the window including the coating layer formed with the two application processes S2.

The second-first image IM2-1 may be an image obtained by capturing a top surface of a window having the average value of the PV values. For example, the second-first image IM2-1 may be an image obtained by capturing a top surface of a window having the PV value of 0.59 wavelength.

The second-second image IM2-2 may be an image obtained by capturing a top surface of a window having the maximum value of the PV values. For example, the second-second image IM2-2 may be an image obtained by capturing a top surface of a window having the PV value of 1.5 wavelength.

The second-first image IM2-1 may have greater uniformity of the thickness CH in the sensor area UA than the first-first image IM1-1. The second-second image IM2-2 may have greater uniformity of the thickness CH in the sensor area UA than the first-second image IM1-2.

An average value of the PV values in the coating layer CL formed with the three application processes S3 may be 0.41 wavelength, and a maximum value of the PV values may be 0.89 wavelength. In this regard, a difference from the average value of the PV values in the two application processes S2 may be 0.18 wavelength. A reference line RL shows a case in which the PV value is 0.92 wavelength.

The third-first image IM3-1 and the third-second image IM3-2 may be images obtained by capturing the window WIN-1 including the coating layer CL formed with the three application processes S3.

The third-first image IM3-1 may be an image obtained by capturing a top surface of the window WIN-1 having the average value of the PV values. For example, the third-first image IM3-1 may be an image obtained by capturing the top surface of the window WIN-1 having the PV value of 0.41 wavelength.

The third-second image IM3-2 may be an image obtained by capturing the top surface of the window WIN-1 having the maximum value of the PV values. For example, the third-second image IM3-2 may be an image obtained by capturing the top surface of the window WIN-1 having the PV value of 0.89 wavelength.

The coating layer CL formed with the three application processes S3 may have the average value of the PV values with a 1.16 wavelength difference from that of the existing coating layer and have the maximum value of the PV values with a 1.68 wavelength difference from that of the existing coating layer.

The third-first image IM3-1 may have greater uniformity of the thickness CH in the sensor area UA than the second-first image IM2-1. The third-second image IM3-2 may have greater uniformity of the thickness CH in the sensor area UA than the second-second image IM2-2.

According to an embodiment of the disclosure, it may be defined that the edge bead phenomenon is reduced or eliminated when the PV value is equal to or greater than the 0.2 wavelength and equal to or smaller than the 0.92 wavelength. The window WIN-1 may be applied with the coating layer for improving the impact resistance of the substrate 10 the plurality of times. The coating layer CL formed with the three application processes S3 may have the PV value equal to or greater than the 0.2 wavelength and equal to or smaller than the 0.92 wavelength. That is, in an embodiment, the edge bead phenomenon in the sensor area UA may be reduced or eliminated such that the optical characteristics of the sensor area UA may be improved. Therefore, the window WIN-1 with the improved impact resistance and flatness may be provided.

An average value of the PV values in the coating layer formed with four application processes S4 may be 0.40 wavelength, and a maximum value of the PV values may be 0.87 wavelength. In this regard, a difference from the average value of the PV values in the three application processes S3 may be 0.01 wavelength.

The fourth-first image IM4-1 and the fourth-second image IM4-2 may be images obtained by capturing the window including the coating layer CL formed with the four application processes S4.

The fourth-first image IM4-1 may be an image obtained by capturing a top surface of a window having the average value of the PV values. For example, the fourth-first image IM4-1 may be an image obtained by capturing a top surface of a window having the PV value of 0.40 wavelength.

The fourth-second image IM4-2 may be an image obtained by capturing a top surface of a window having the maximum value of the PV values. For example, the fourth-second image IM4-2 may be an image obtained by capturing a top surface of a window having the PV value of 0.87 wavelength.

There may be no substantial difference in the PV values between the coating layer CL with the three application processes S3 and the coating layer formed with the four application processes S4. In the window WIN-1 manufacturing method according to an embodiment of the disclosure, the number of application processes S3 may be limited to three. If the number of times of application processes S4 is equal to or greater than four, the appearance quality of the window may deteriorate and the productivity may decrease.

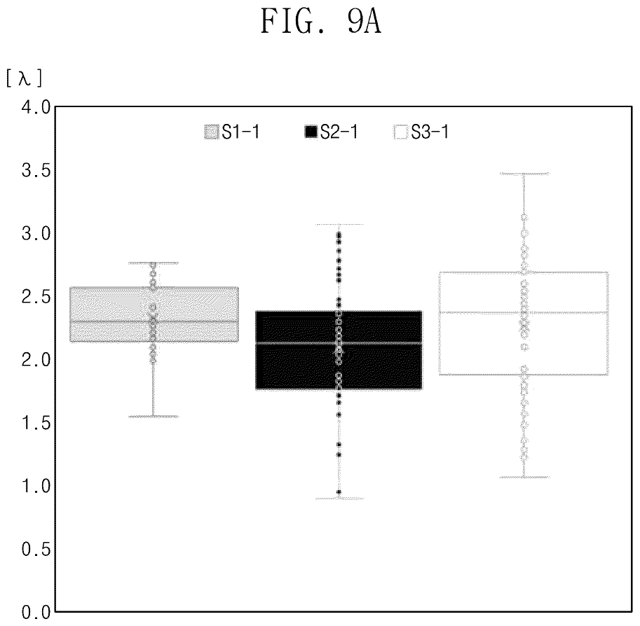

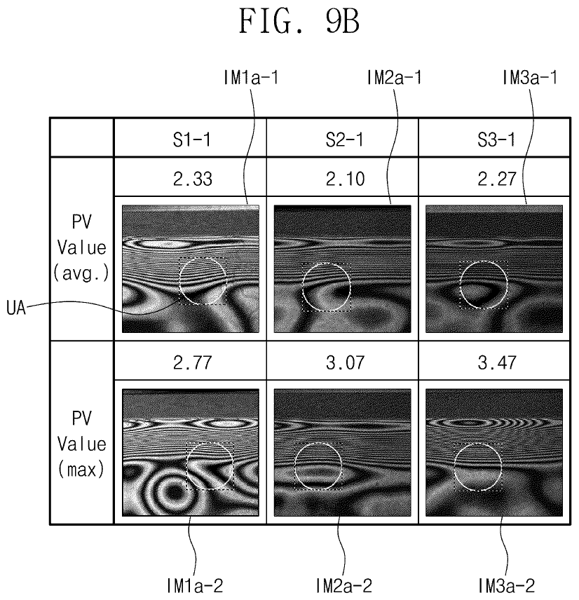

FIG. 9A is a box graph showing a PV value based on the number of times of application according to an embodiment of the disclosure, and FIG. 9B may show captured images of a window based on the number of times of application according to an embodiment of the disclosure.

Referring to FIGS. 6J, 9A, and 9B, a vertical axis in FIG. 9A represents the PV value. The PV value shows 0 wavelength to 4.0 wavelength as an example. FIG. 9A shows each PV value measured based on each number of times of application when the thickness CH of the coating layer CL is greater than 30 μm as an example.

Each of images IM1a-1 to IM3a-2 obtained by capturing the window shows the thickness via the level curve.

An average value of the PV values in the coating layer formed with a single application process S1-1 may be 2.33 wavelength, and a maximum value of the PV values may be 2.77 wavelength.

The image IM1a-1 and the first-second image IM1a-2 may be images obtained by capturing the window including the coating layer formed with the single application process S1-1.

The image IM1a-1 may be an image obtained by capturing a top surface of a window having the average value of the PV values. For example, the first-first image IM1a-1 may be an image obtained by capturing a top surface of a window having the PV value of 2.33 wavelength.

The image IM1a-2 may be an image obtained by capturing a top surface of a window having the maximum value of the PV values. For example, the first-second image IM1a-2 may be an image obtained by capturing a top surface of a window having the PV value of 2.77 wavelength.

An average value of the PV values in the coating layer formed with four application processes S2-1 may be 2.10 wavelength, and a maximum value of the PV values may be 3.07 wavelength. In this regard, a difference from the average value of the PV values in the single application process S1-1 may be 0.23 wavelength.

The second-first image IM2a-1 and the second-second image IM2a-2 may be images obtained by capturing the window including the coating layer formed with the fourth application processes S2-1.

The second-first image IM2a-1 may be an image obtained by capturing a top surface of a window having the average value of the PV values. For example, the second-first image IM2a-1 may be an image obtained by capturing a top surface of a window having the PV value of 2.10 wavelength.

The second-second image IM2a-2 may be an image obtained by capturing a top surface of a window having the maximum value of the PV values. For example, the second-second image IM2a-2 may be an image obtained by capturing a top surface of a window having the PV value of 3.07 wavelength.

An average value of the PV values in the coating layer formed with five application processes S3-1 may be 2.27 wavelength, and a maximum value of the PV values may be 3.47 wavelength. In this regard, a difference from the average value of the PV values in the four application processes S2-1 may be 0.06.

The third-first image IM3a-1 and the third-second image IM3a-2 may be images obtained by capturing the window including the coating layer formed with the five application processes S3-1.

The third-first image IM3a-1 may be an image obtained by capturing a top surface of the window having the average value of the PV values. For example, the third-first image IM3a-1 may be an image obtained by capturing the top surface of the window having the PV value of 2.27 wavelength.

The third-second image IM3a-2 may be an image obtained by capturing the top surface of the window having the maximum value of the PV values. For example, the third-second image IM3a-2 may be an image obtained by capturing the top surface of the window having the PV value of 3.47 wavelength.

If the thickness CH of the coating layer CL exceeds 30 μm, the effect of the multi-stage coating of applying the coating layer the plurality of times may be small. That is, even when the coating layer CL is formed via the multi-stage coating, the edge bead phenomenon may occur. According to an embodiment of the disclosure, the thickness CH of the coating layer CL may be in the range from 20 μm to 30 μm. In an embodiment, where the coating layer CL is formed via the multi-stage coating, the coating layer CL may have the PV value equal to or greater than the 0.2 wavelength and equal to or smaller than the 0.92 wavelength. In such an embodiment, the edge bead phenomenon in the sensor area UA may be reduced or eliminated such that the optical characteristics of the sensor area UA may be improved. Therefore, the window WIN-1 with the improved impact resistance and flatness may be provided.

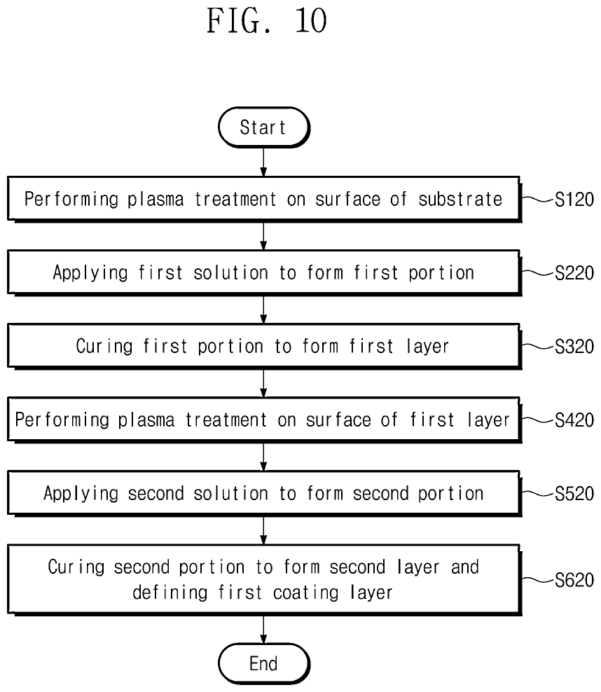

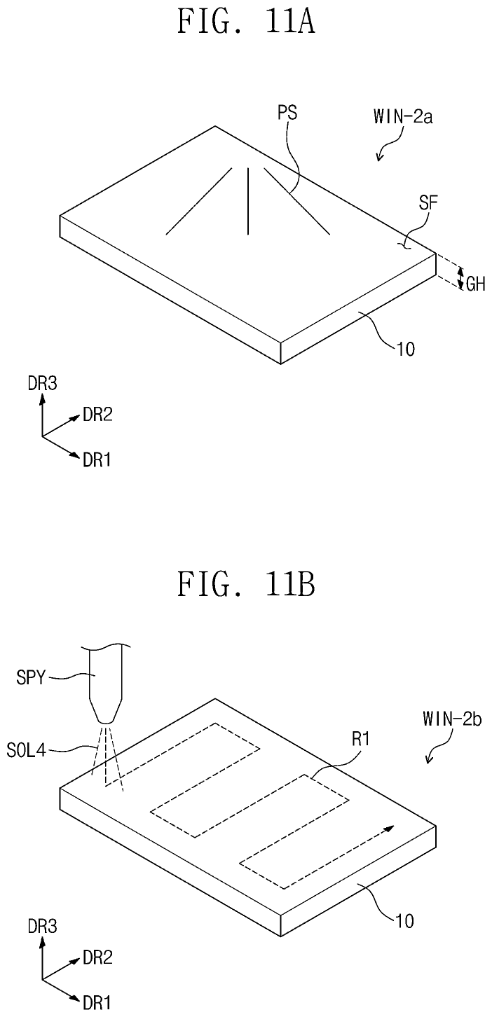

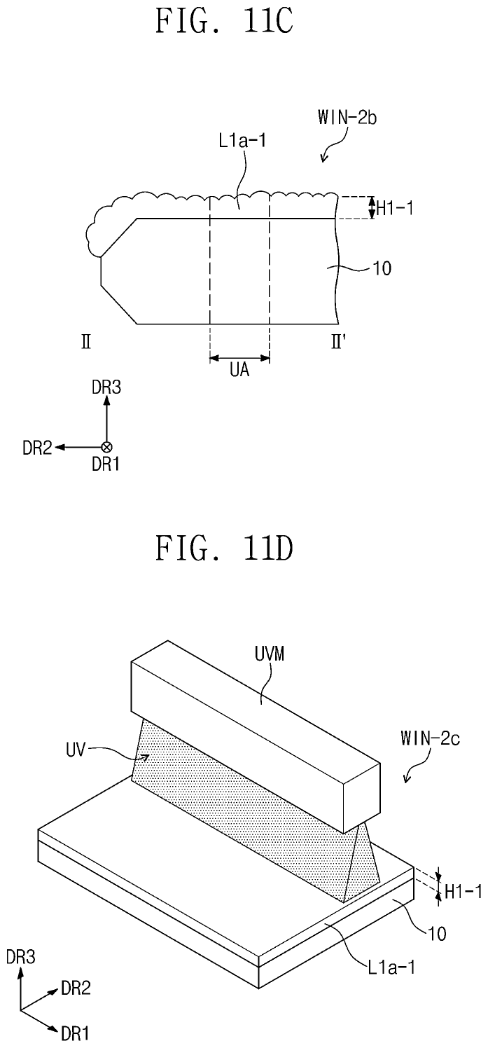

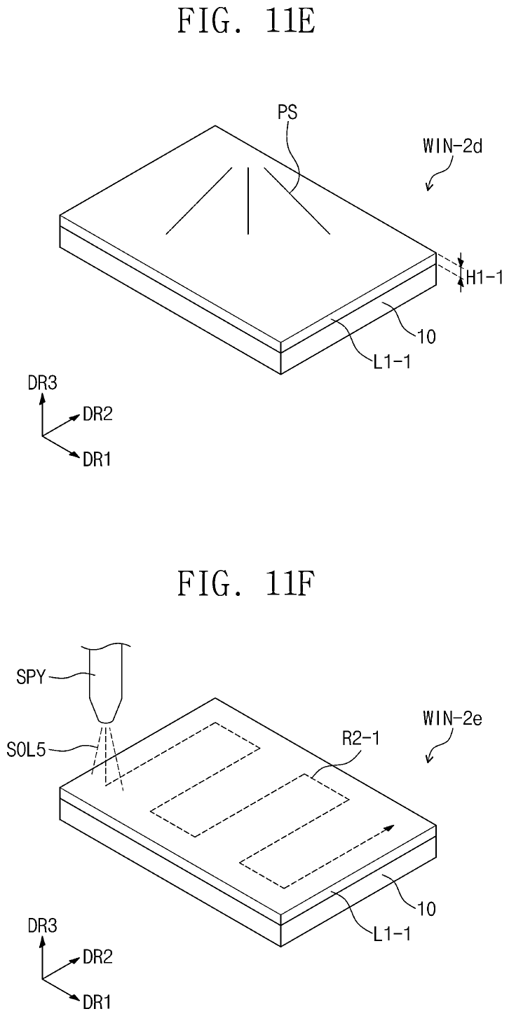

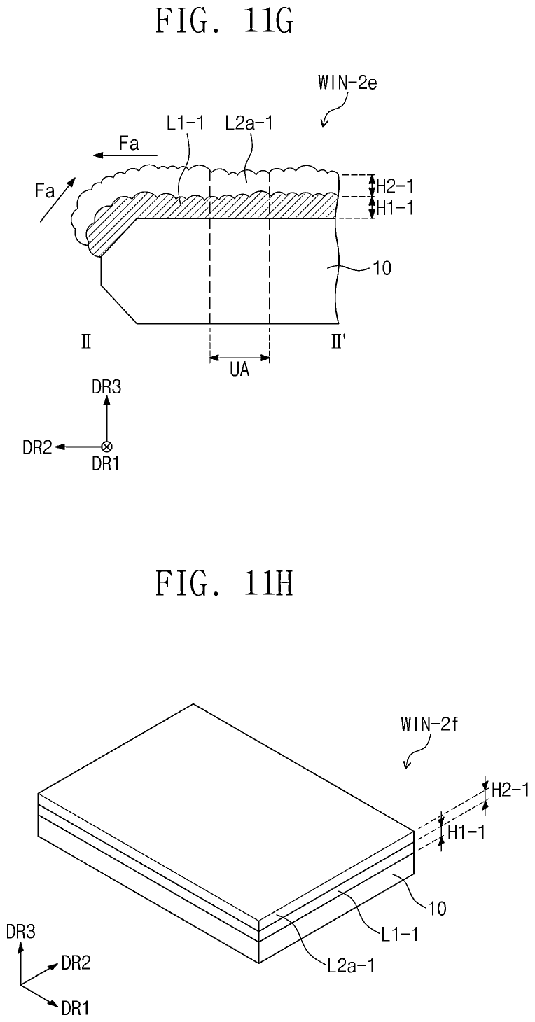

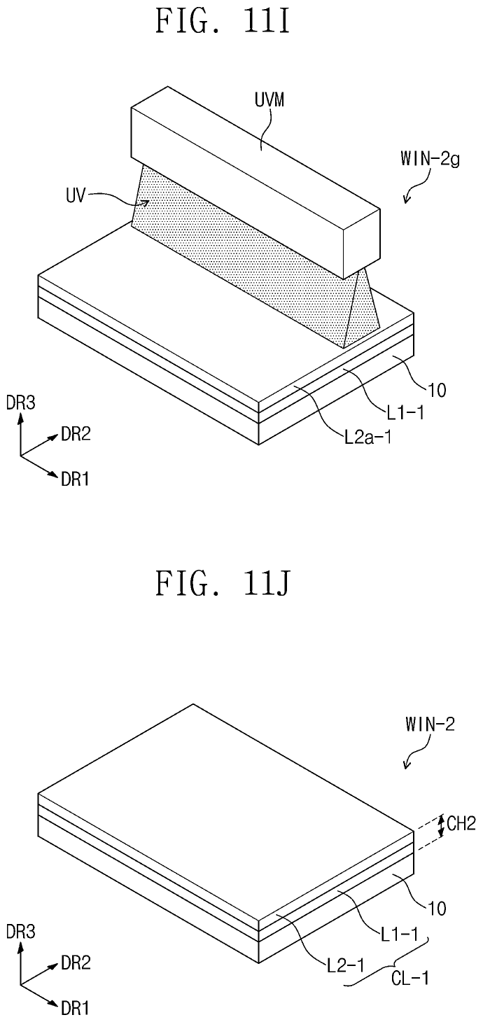

FIG. 10 is a flowchart illustrating a window manufacturing method according to an embodiment of the disclosure, and FIG. 11A is a perspective view showing a process of a window manufacturing method according to an embodiment of the disclosure. In FIG. 11A, the same or like components as those described above with referent to FIG. 6A are labeled with the same or like reference characters, and any repetitive detailed descriptions thereof will be omitted.

Referring to FIGS. 10 and 11A, an embodiment of a method for manufacturing the window WIN (see FIG. 3) may include performing the plasma treatment on the surface of the substrate 10 (S120), applying the first solution to form the first portion (S220), curing the first portion to form a first layer (S320), performing the plasma treatment on a surface of the first layer (S420), applying the second solution to form the second portion (S520), and curing the second portion to form a second layer and defining the first coating layer (S620). This will be described later.

FIG. 11A shows the process of performing the plasma treatment on the surface of the substrate 10 (S120).

A preliminary window WIN-2a may include the substrate 10. The plasma PS may be provided in the preliminary window WIN-2a for the plasma treatment. The plasma PS may pre-treat the surface SF of the substrate 10.

FIG. 11B is a perspective view showing a process of a window manufacturing method according to an embodiment of the disclosure, and FIG. 11C is a cross-sectional view of a preliminary window cut along a line corresponding to II-II′ in FIG. 1A according to an embodiment of the disclosure. FIG. 11B shows the process of applying the first solution to form the first portion. In FIG. 11B, the same or like components as those described above with referent to FIG. 6B are labeled with the same or like reference characters, and any repetitive detailed descriptions thereof will be omitted.

Referring to FIGS. 10, 11B, and 11C, a fourth solution SOL4 may be applied to a preliminary window WIN-2b. The fourth solution SOL4 may be applied onto the substrate 10, and a first portion L1a-1 may be formed (S220). The process of forming the first portion L1a-1 (S220) may be referred to as the first application operation (S220).

The fourth solution SOL4 may be substantially the same as the first solution SOL1 (see FIG. 6A). The fourth solution SOL4 may not include a leveling agent.

The fourth solution SOL4 may be applied by the spray coating method. The spray nozzle SPY may apply the fourth solution SOL4 to the surface SF (see FIG. 11A) of the substrate 10. In the first application operation (S220), the fourth solution SOL4 applied onto the substrate 10 may be provided in a capacity of about 5.4 cc.

However, this is an example, and the capacity of the fourth solution SOL4 according to an embodiment of the disclosure is not limited thereto. The fourth solution SOL4 may be provided in the capacity based on a thickness H1-1 of the first portion L1a-1.

The fourth solution SOL4 may be applied along a path in a zigzag shape along the first direction DR1. For example, the fourth solution SOL4 may be applied in a ‘ [symbol] ’ shape path along the first direction DR1. The fourth solution SOL4 may be applied onto the substrate 10 along the first path R1.

The fourth solution SOL4 applied onto the substrate 10 may be formed into the first portion L1a-1. The first portion L1a-1 may be a liquid.

The first portion L1a-1 may be formed with the first thickness H1-1.

The first thickness H1-1 may be in a range from about 10 μm to about 15 μm. If the first thickness H1-1 exceeds about 15 μm, the edge bead phenomenon occurs in the first portion L1a-1 to deteriorate the optical characteristics in the sensor area UA when further forming a second layer L2-1 (see FIG. 11J).

According to an embodiment of the disclosure, the edge bead phenomenon may be reduced or eliminated because of the small thickness of the first portion L1a-1. The first portion L1a-1 may be applied with a uniform top surface. The window WIN (see FIG. 2) may be applied with the coating layer for improving the impact resistance of the substrate 10 the plurality of times. In such an embodiment, the first portion L1a-1 having the uniform top surface may be formed in the sensor area UA such that the optical characteristics of the sensor area UA may be improved.

Therefore, the window WIN (see FIG. 2) with the improved impact resistance and flatness may be provided.

FIGS. 11D to 11E are perspective views showing a process of a window manufacturing method according to an embodiment of the disclosure.

Referring to FIGS. 10, 11D, and 11E, a first layer L1-1 may be formed in a preliminary window WIN-2c (S320).

The curing module UVM may be disposed on the preliminary window WIN-2c. The curing module UVM may radiate the ultraviolet ray UV to the preliminary window WIN-2c. The curing module UVM may move along the second direction DR2.

In the forming of the first layer L1-1 (S320), the first portion L1a-1 may be cured using the ultraviolet ray UV.

The cured first portion L1a-1 may be a solid. The cured first portion L1a-1 may be referred to as the first layer L1-1. That is, the first layer L1-1 may be a solid layer.

The first layer L1-1 may have the first thickness H1-1.

A preliminary window WIN-2d may include the substrate 10 and the first layer L1-1. The plasma PS may be provided to the preliminary window WIN-2d. The plasma PS may pre-treat a surface of the first layer L1-1.

FIG. 11F is a perspective view showing one step of a window manufacturing method according to an embodiment of the disclosure, FIG. 11G is a cross-sectional view of a preliminary window cut along a line corresponding to II-II′ in FIG. 1A according to an embodiment of the disclosure, and FIG. 11H is a perspective view showing a process of a window manufacturing method according to an embodiment of the disclosure.

Referring to FIGS. 10, 11F, 11G, and 11H, a fifth solution SOL5 may be applied to a preliminary window WIN-2e. The fifth solution SOL5 may be applied onto the first layer L1-1, and a second portion L2a-1 may be formed (S520). The process of forming the second portion L2a-1 may be referred to as the second application operation (S520).

The fifth solution SOL5 may be different from the fourth solution SOL4. The fifth solution SOL5 may further include the leveling agent in addition to the fourth solution SOL4.

The fifth solution SOL5 may be applied by the spray coating method. The spray nozzle SPY may apply the fifth solution SOL5 onto the first layer L1-1. In the second application operation (S520), the fifth solution SOL5 applied onto the first layer L1-1 may be provided in a capacity of about 5.4 cc.

The fifth solution SOL5 may be applied along a path in a zigzag shape along the first direction DR1. For example, the fifth solution SOL5 may be applied in a ‘ [symbol] ’ shape along the first direction DR1. The fifth solution SOL5 may be applied onto the first layer L1-1 along a second path R2-1. The second path R2-1 may be substantially the same as the first path R1 (see FIG. 11B).

The fifth solution SOL5 applied onto the first layer L1-1 may be formed into the second portion L2a-1. The second portion L2a-1 may be a liquid.

The portion L2a-1 may be formed with a second thickness H2-1. The second thickness H2-1 may be in a range from about 10 μm to about 15 μm.

TABLE 3

| | Non-polar portion | Polar portion | Sum |
|---|---|---|---|
| First layer | 16.9 | 2.1 | 36.9 |
| Second portion | 16.9 | 2.1 | 19.0 |

| | |
|---|---|
| Interfacial tension Fa | 0 |

Table 3 above shows a surface tension of the first layer L1-1, a surface tension of the second portion L2a-1, and an interfacial tension (Fa) between the first layer L1-1 and the second portion L2a-1 calculated using Mathematical Formula 1described above. A contact angle between first layer L1-1 and second portion L2a-1 may be 8.6°. According to the disclosure, referring to Table 3, the first layer L1-1 may be cured by the ultraviolet ray UV (FIG. 11D), so that an effect of the polarity of the substrate 10 may be reduced or eliminated. The interfacial tension (Fa) between the first layer L1-1 and the second portion L2a-1 may have a value of 0 or a value close to 0. Accordingly, the edge bead phenomenon may be reduced. In an embodiment, the coating layer may be applied a plurality of times to improve the impact resistance of the substrate 10. In such an embodiment, the second portion L2a-1 with a uniform top surface may be formed in the sensor area UA such that the optical characteristics of the sensor area UA may be improved. Therefore, the window WIN (see FIG. 2) with the improved impact resistance and flatness may be provided.

A preliminary window WIN-2f in which the application process is completed may have a shape in which the first layer L1-1 and the second portion L2a-1 are sequentially stacked on the substrate 10.

The thickness H1-1 of the first layer L1-1 and the thickness H2-1 of the second portion L2a-1 may be substantially equal to each other.

FIGS. 11I and 11J are perspective views showing a process of a window manufacturing method according to an embodiment of the disclosure.

Referring to FIGS. 10, 11I, and 11J, a coating layer CL-1 may be formed in a preliminary window WIN-2g (S620). The process of forming the coating layer CL-1 (S620) may be referred to as the operation of defining the coating layer CL-1 (S620).

The curing module UVM may be disposed on the preliminary window WIN-2g. The curing module UVM may radiate the ultraviolet ray UV to the preliminary window WIN-2g. The curing module UVM may move along the second direction DR2.

In the operation of defining the coating layer CL-1 (S620), the second portion L2a-1 may be cured using the ultraviolet ray UV. Conditions for curing the second portion L2a-1 may be substantially the same as conditions for curing the first portion L1a-1.

The cured second portion L2a-1 may be a solid. The cured second portion L2a-1 may be referred to as the second layer L2-1. That is, the second layer L2-1 may be a solid layer. In this regard, the defining of the coating layer CL-1 (S620) by forming the first layer L1-1 (S320) and the second layer L2-1 (S620) may be referred to as a multi-layer coating method.

The first layer L1-1 and the second layer L2-1 may be referred to as the coating layer CL-1. That is, the coating layer CL-1 may include the first layer L1-1 and the second layer L2-1.

The coating layer CL-1 according to an embodiment of the disclosure may include two to three layers. If the coating layer CL-1 includes four or more layers, a repulsive force between the plurality of layers may increase, and a buckling risk resulted from a decrease in an interfacial adhesion may occur. As a result, reliability may decrease during the folding operation of the electronic device 1000.

A window WIN-2 may be manufactured by an embodiment of the window manufacturing method. The window WIN-2 may include the substrate 10 and the coating layer CL-1. The coating layer CL-1 may be disposed on the substrate 10. The coating layer CL-1 may improve the impact resistance of the substrate 10 and prevent the substrate 10 from being shattered or scattered when the substrate 10 is damaged.

The coating layer CL-1 may have a predetermined thickness CH2. In an embodiment, the thickness CH2 may be in a range from about 25 μm to about 35 μm. If the thickness CH2 is smaller than about 25 μm, it may be controlled such that the edge bead phenomenon does not occur at the sensor area UA without using the multi-layer coating method, and if the thickness CH2 is greater than about 35 μm, the repulsive force between the plurality of layers L1-1 and L2-1 may increase and the buckling risk may occur resulted from the decrease in the interfacial adhesion. As a result, the reliability may decrease during the folding operation of the electronic device 1000.

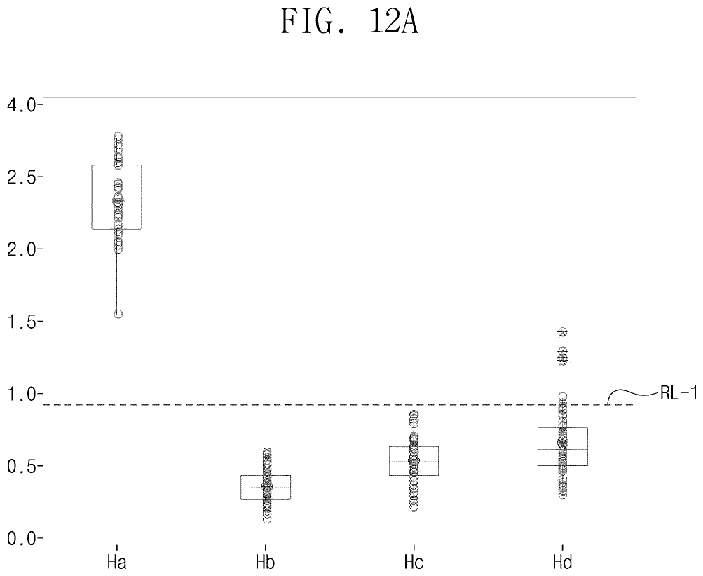

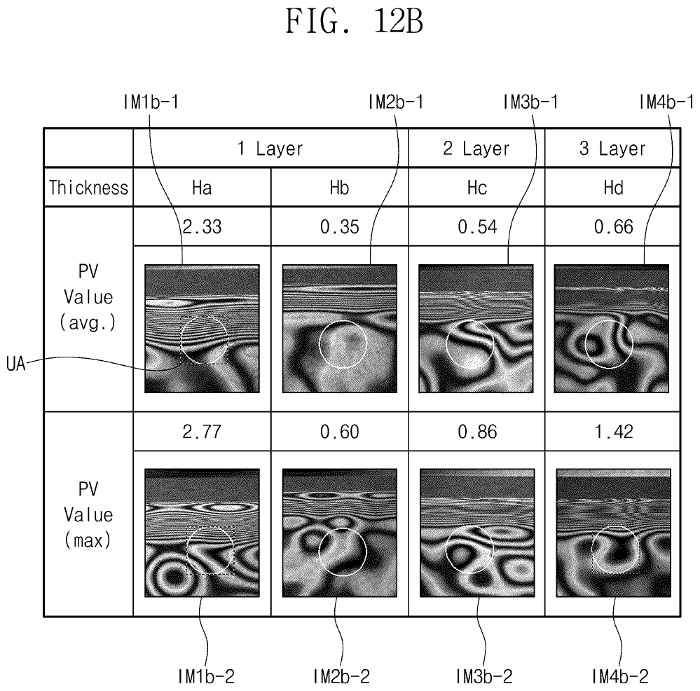

FIG. 12A is a box graph showing a PV value based on the number of layers of a coating layer according to an embodiment of the disclosure, and FIG. 12B shows captured images of a window based on the number of layers of a coating layer according to an embodiment of the disclosure.

Referring to FIGS. 11J, 12A, and 12B, in FIG. 12A, a horizontal axis shows the coating layers CL-1 classified based on the thickness, and a vertical axis shows the PV value. The PV value shows 0 wavelength to 4.0 wavelength as an example. In this regard, 1 wavelength may be about 632.8 nm.

Each of images IM1b-1 to IM4b-2 obtained by capturing the window WIN-2 shows the thickness CH2 via the level curve.

The coating layer formed of a single layer may have a first thickness Ha. The first thickness Ha may be 30 μm. In this regard, an average value of the PV values may be 2.33 wavelength, and a maximum value of the PV values may be 2.77 wavelength.

The image IM1b-1 and the first-second image IM1b-2 may be images obtained by capturing the window including the coating layer formed of the single layer and with the first thickness Ha.

The image IM1b-1 may be an image obtained by capturing a top surface of a window having the average value of the PV values. For example, the first-first image IM1b-1 may be an image obtained by capturing a top surface of a window having the PV value of 2.33 wavelength.

The image IM1b-2 may be an image obtained by capturing a top surface of a window having the maximum value of the PV values. For example, the first-second image IM1b-2 may be an image obtained by capturing a top surface of a window having the PV value of 2.77 wavelength.

The coating layer formed of the single layer may have a second thickness Hb. The second thickness Hb may be 15 μm. In this regard, the average value of the PV values may be 0.35 wavelength, and the maximum value of the PV values may be 0.60 wavelength. In this regard, a difference from the average value of the PV values in the coating layer having the first thickness Ha may be 1.98 wavelength. A reference line RL-1 shows a case in which the PV value is 0.92 wavelength.

The image IM2b-1 and the second-second image IM2b-2 may be images obtained by capturing the window including the coating layer formed of the single layer and with the second thickness Hb.

The second-first image IM2b-1 may be an image obtained by capturing a top surface of a window having the average value of the PV values. For example, the second-first image IM2b-1 may be an image obtained by capturing a top surface of the window having the PV value of 0.35 wavelength.

The image IM2b-2 may be an image obtained by capturing a top surface of a window having the maximum value of the PV values. For example, the second-second image IM2b-2 may be an image obtained by capturing a top surface of a window having the PV value of 0.60 wavelength.

The coating layer CL-1 using the multi-layer coating method according to an embodiment of the disclosure may have the thickness CH2 in the range from 25 μm to 35 μm. In a case where the thickness CH2 is smaller than 25 μm, even when the coating layer is formed of the single layer without using the multi-layer coating method, like the coating layer formed of the single layer and with the second thickness Hb, the PV value may be equal to or greater than 0.2 wavelength and equal to or smaller than 0.92 wavelength.

The coating layer CL-1 formed of two layers may have a third thickness Hc. The third thickness Hc may be about 28 μm. In this regard, the average value of the PV values may be 0.54 wavelength, and the maximum value of the PV values may be 0.86 wavelength. In this regard, a difference from the average value of the PV values in the coating layer having the first thickness Ha may be 1.79 wavelength.

The third-first image IM3b-1 and the third-second image IM3b-2 may be images obtained by capturing the window WIN-2 including the coating layer CL-1 formed of the two layers and with the third thickness Hc.

The third-first image IM3b-1 may be an image obtained by capturing a top surface of the window WIN-2 having the average value of the PV values. For example, the third-first image IM3b-1 may be an image obtained by capturing a top surface of the window WIN-2 having the PV value of 0.54 wavelength.

The third-second image IM3b-2 may be an image obtained by capturing a top surface of the window WIN-2 having the maximum value of the PV values. For example, the third-second image IM3b-2 may be an image obtained by capturing a top surface of the window WIN-2 having the PV value of 0.86 wavelength.

The third-first image IM3b-1 may have greater uniformity of the thickness CH2 in the sensor area UA than the first-first image IM1b-1. The third-second image IM3b-2 may have greater uniformity of the thickness CH2 in the sensor area UA than the first-second image IM1b-2.

According to an embodiment of the disclosure, it may be defined that the edge bead phenomenon is reduced or eliminated when the PV value is equal to or greater than 0.2 wavelength and equal to or smaller than 0.92 wavelength. The window WIN-2 may be applied with the coating layer for improving the impact resistance of the substrate 10 the plurality of layers. In such an embodiment, the coating layer CL-1 formed of the two layers and with the third thickness Hc may have the PV value equal to or greater than 0.2 wavelength and equal to or smaller than 0.92 wavelength. In such an embodiment, the edge bead phenomenon in the sensor area UA may be reduced or eliminated such that the optical characteristics of the sensor area UA may be improved. Therefore, the window WIN-2 with the improved impact resistance and flatness may be provided.

The coating layer formed of the three layers may have a fourth thickness Hd. The fourth thickness Hd may be 40 μm. In this regard, the average value of the PV values may be 0.66 wavelength, and the maximum value of the PV values may be 1.42 wavelength. In this regard, a difference from the average value of the PV values in the coating layer having the first thickness Ha may be 1.67 wavelength.

The fourth-first image IM4b-1 and the fourth-second image IM4b-2 may be images obtained by capturing the window including the coating layer formed of the three layers and with the fourth thickness Hd.

The fourth-first image IM4b-1 may be an image obtained by capturing a top surface of a window having the average value of the PV values. For example, the fourth-first image IM4b-1 may be an image obtained by capturing a top surface of a window having the PV value of 0.66 wavelength.

The fourth-second image IM4b-2 may be an image obtained by capturing a top surface of a window having the maximum value of the PV values. For example, the fourth-second image IM4b-2 may be an image obtained by capturing a top surface of a window having the PV value of 1.42 wavelength.

The coating layer CL-1 using the multi-layer coating method according to one embodiment of the disclosure may have the thickness CH2 in the range from 25 μm to 35 μm. In a case where the thickness CH2 is greater than 35 μm, the repulsive force between the plurality of layers may increase and the buckling risk resulted from the decrease in the interfacial adhesion may increase. Accordingly, the PV value may deviate from the range equal to or greater than 0.2 wavelength and equal to or smaller than 0.92 wavelength.

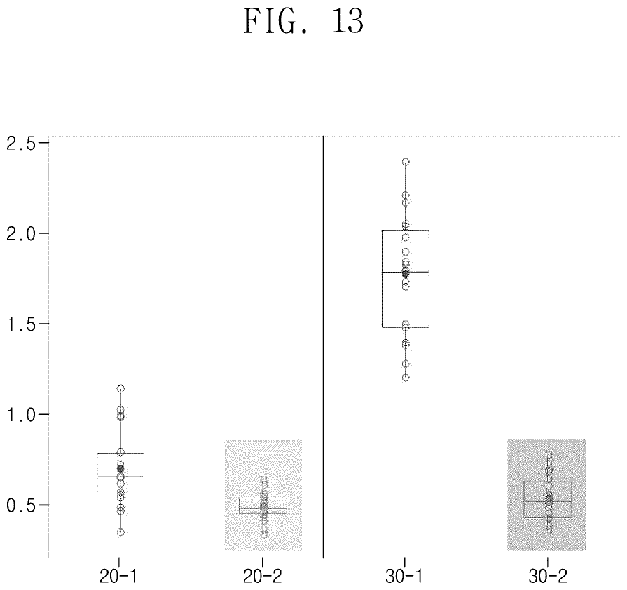

FIG. 13 is a box graph showing a PV value of a window formed using multi-stage coating and multi-layer coating methods according to an embodiment of the disclosure.

Referring to FIGS. 6J, 11J, and 13, in a process 20-1 of forming a single layer with one application, in a window including a coating layer having a thickness of 20 μm, an average value of PV values may be 0.70 wavelength, and a maximum value of the PV values may be 1.14 wavelength. The coating layer formed by the process 20-1 may be referred to as a first existing coating layer.

In the window WIN-1 including the coating layer CL having the thickness of 20 μm using a multi-stage coating process 20-2 according to an embodiment of the disclosure, the average value of the PV values may be 0.49 wavelength, and the maximum value of the PV values may be 0.63 wavelength. The coating layer CL formed by the multi-stage coating process 20-2 may have the average value of the PV values with a 0.21 wavelength difference from that of the first existing coating layer and have the maximum value of the PV values with a 0.51 wavelength difference from that of the first existing coating layer.

According to an embodiment of the disclosure, it may be defined that the edge bead phenomenon is reduced or eliminated when the PV value is equal to or greater than 0.2 wavelength and equal to or smaller than 0.92 wavelength. The window WIN-1 may be applied with the coating layer for improving the impact resistance of the substrate 10 the plurality of times. The coating layer CL formed by the multi-stage coating process 20-2 may have a thickness in a range from 20 μm to 30 μm, and a PV value equal to or greater than 0.2 wavelength and equal to or smaller than 0.92 wavelength. In such an embodiment, the edge bead phenomenon in the sensor area UA (see FIG. 1A) may be reduced or eliminated such that the optical characteristics of the sensor area UA (see FIG. 1A) may be improved. Therefore, the window WIN-1 with the improved impact resistance and flatness may be provided.

In a process 30-1 of forming a single layer with one application, in a window including a coating layer having a thickness of 30 μm, an average value of PV values may be 1.77 wavelength, and a maximum value of the PV values may be 2.39 wavelength. The coating layer formed by the process 30-1 may be referred to as a second existing coating layer.

In the window WIN-2 including the coating layer CL-1 having the thickness of 30 μm using a multi-layer coating process 30-2 according to an embodiment of the disclosure, the average value of the PV values may be 0.53 wavelength, and the maximum value of the PV values may be 0.77 wavelength. The coating layer CL-1 formed by the multi-layer coating process 30-2 may have the average value of the PV values with a 1.23 wavelength difference from that of the second existing coating layer and have the maximum value of the PV values with a 1.62 wavelength difference from that of the second existing coating layer.

According to an embodiment of the disclosure, it may be defined that the edge bead phenomenon is reduced or eliminated when the PV value is equal to or greater than 0.2 wavelength and equal to or smaller than 0.92 wavelength. The window WIN-2 may be applied with the coating layer for improving the impact resistance of the substrate 10 the plurality of times. The coating layer CL-1 formed by the multi-layer coating process 30-2 may have the thickness in the range from 25 μm to 35 μm, and the PV value equal to or greater than 0.2 wavelength and equal to or smaller than 0.92 wavelength. In such an embodiment, the edge bead phenomenon in the sensor area UA (see FIG. 1A) may be reduced or eliminated such that the optical characteristics of the sensor area UA (see FIG. 1A) may be improved. Therefore, the window WIN-2 with the improved impact resistance and flatness may be provided.

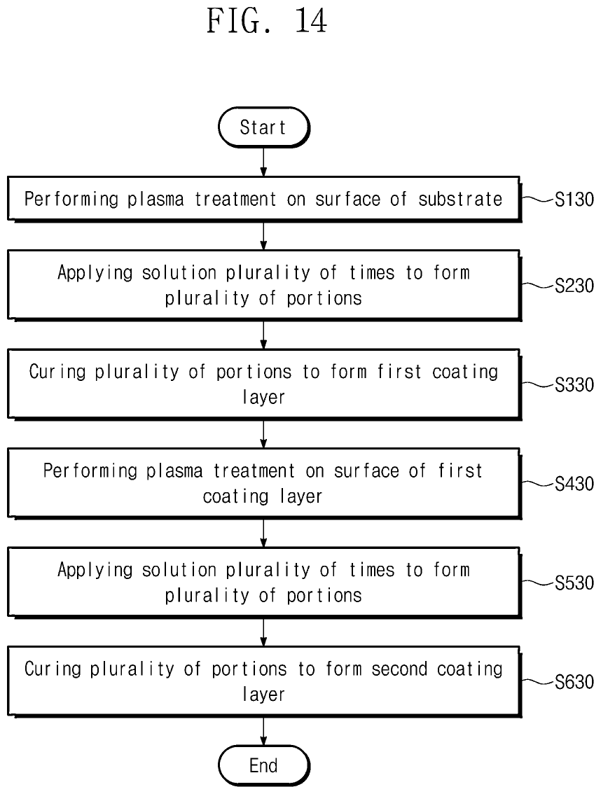

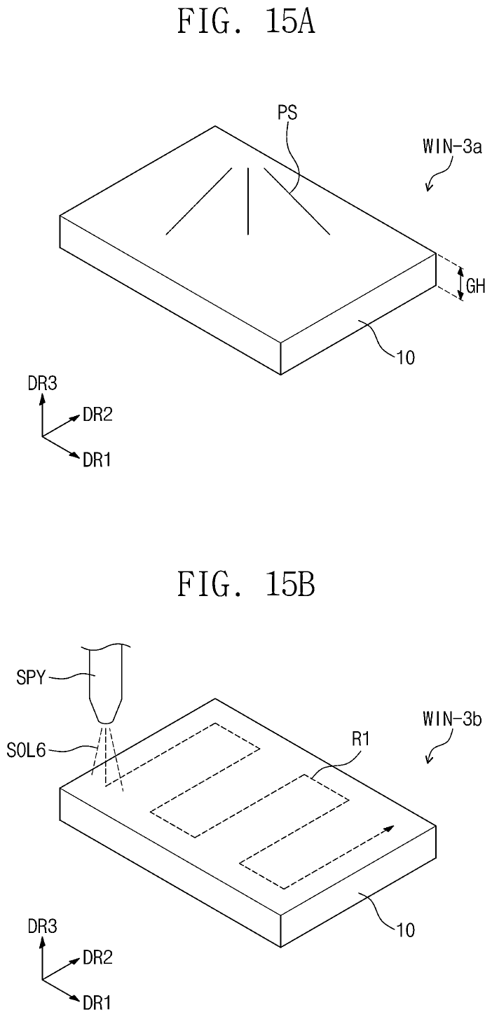

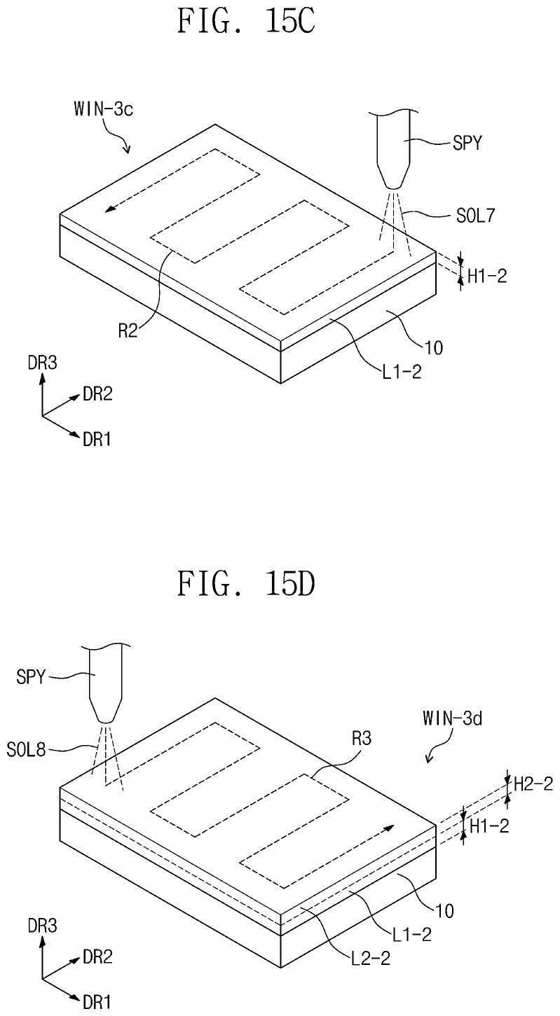

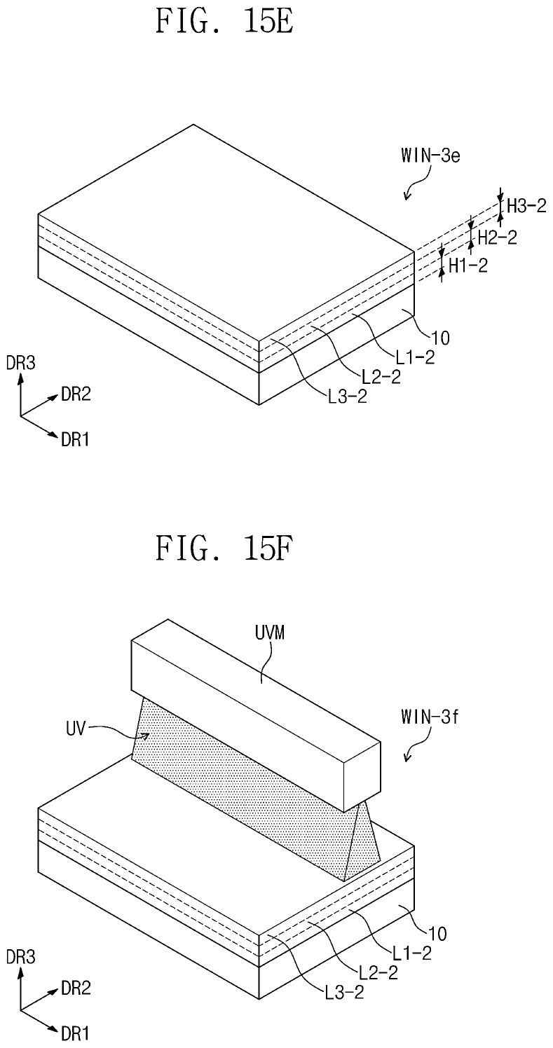

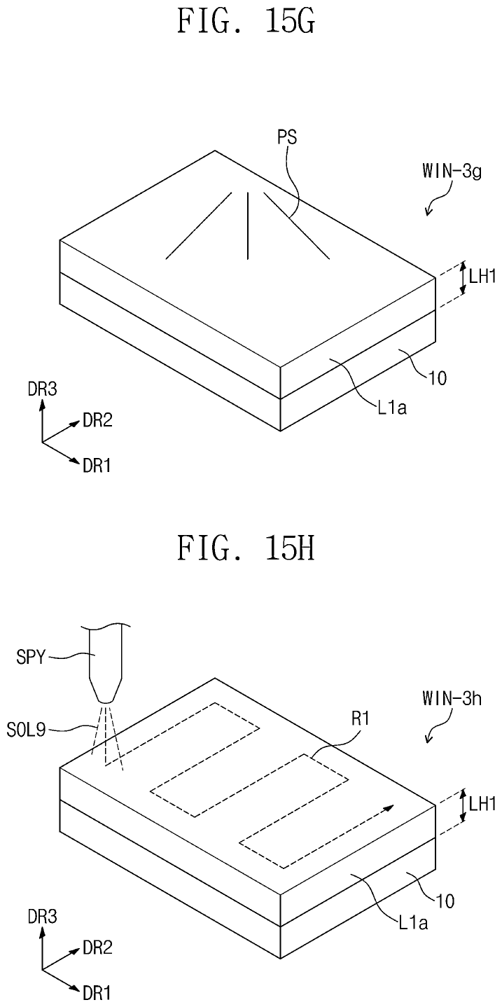

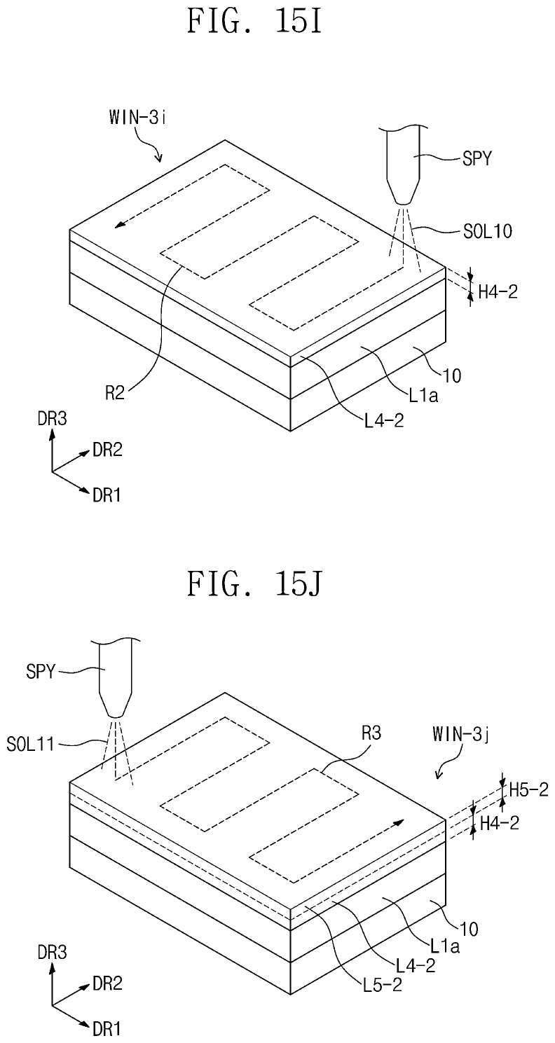

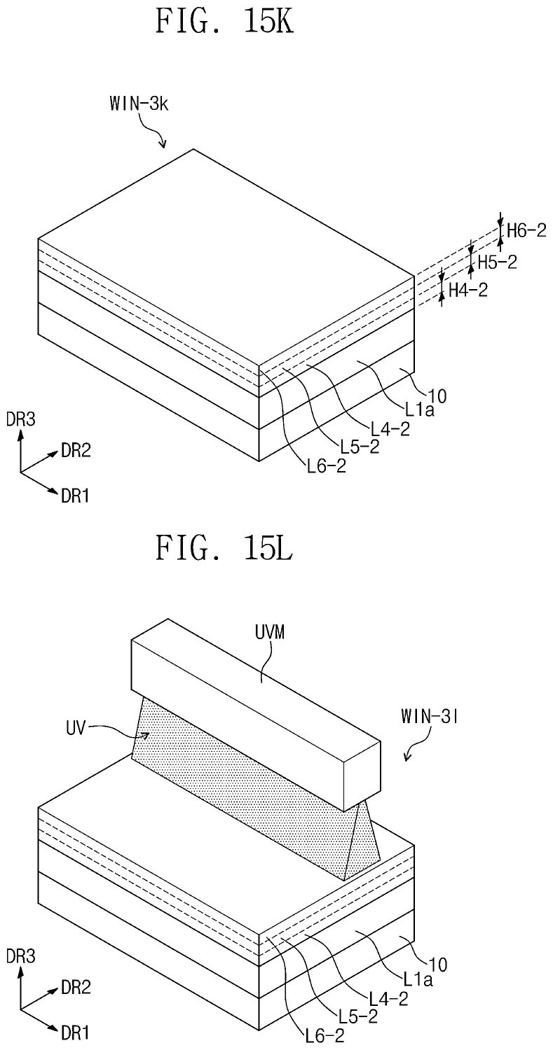

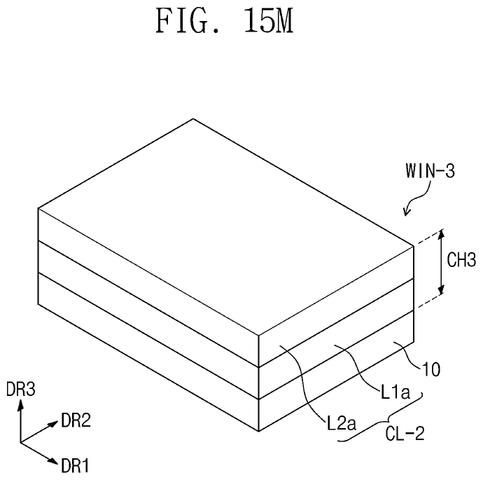

FIG. 14 is a flowchart showing a window manufacturing method according to an embodiment of the disclosure, and FIG. 15A is a perspective view showing a process of a window manufacturing method according to an embodiment of the disclosure. In FIG. 15A, the same or like components as those described above with referent to FIG. 6A are labeled with the same or like reference characters, and any repetitive detailed descriptions thereof will be omitted.

Referring to FIGS. 14 and 15A, an embodiment of a method for manufacturing the window WIN (see FIG. 3) may include performing the plasma treatment on the surface of the substrate 10 (S130), applying the solution the plurality of times to form a plurality of portions (S230), curing the plurality of portions to form the first coating layer (S330), performing the plasma treatment on the surface of the first coating layer (S430), applying the solution the plurality of times to form a plurality of portions (S530), and curing the plurality of portions to form the second coating layer (S630). This will be described later.

FIG. 15A shows the process of performing the plasma treatment on the surface of the substrate 10 (S130).

In an embodiment, a preliminary window WIN-3a may include the substrate 10. The plasma PS may be provided to the preliminary window WIN-3a for the plasma treatment. The plasma PS may pre-treat the surface of the substrate 10.

FIGS. 15B to 15E are perspective views showing a process of a window manufacturing method according to an embodiment of the disclosure.

Referring to FIGS. 14, 15B, 15C, 15D, and 15E, the plurality of portions may be formed by applying the solution the plurality of times (S230).

A sixth solution SOL6 may be applied to a preliminary window WIN-3b. The sixth solution SOL6 may be applied onto the substrate 10, and a first portion L1-2 may be formed. The sixth solution SOL6 may be substantially the same as the first solution SOL1 (see FIG. 6A).

The sixth solution SOL6 may be applied by the spray coating method. The spray nozzle SPY may apply the sixth solution SOL6 to the surface of the substrate 10.

The sixth solution SOL6 may be applied along a path in a zigzag shape along the first direction DR1. For example, the sixth solution SOL6 may be applied in a ‘ [symbol] ’ shape along the first direction DR1. The sixth solution SOL6 may be applied on the substrate 10 along the first path R1.

The sixth solution SOL6 applied onto the substrate 10 may be formed into the first portion L1-2. The first portion L1-2 may be a liquid.

The first portion L1-2 may be formed with a first thickness H1-2. The first thickness H1-2 may be in a range from 3.3 μm to 6.7 μm.

A seventh solution SOL7 may be applied to a preliminary window WIN-3c. The seventh solution SOL7 may be applied onto the first portion L1-2, and a second portion L2-2 may be formed. The seventh solution SOL7 may be substantially the same as the sixth solution SOL6.

The seventh solution SOL7 may be applied by the spray coating method. The spray nozzle SPY may apply the seventh solution SOL7 onto the first portion L1-2.

The seventh solution SOL7 may be applied along a path in a zigzag shape along the direction opposite to the first direction DR1. For example, the seventh solution SOL7 may be applied in a ‘ [symbol] ’ shape along the direction opposite to the first direction DR1. The seventh solution SOL7 may be applied onto the first portion L1-2 along the second path R2.

The seventh solution SOL7 applied onto the first portion L1-2 may be formed into the second portion L2-2. The second portion L2-2 may be a liquid.

The portion L2-2 may be formed with a second thickness H2-2. The second thickness H2-2 may be in a range from 3.3 μm to 6.7 μm. The second thickness H2-2 may be substantially the same as the first thickness H1-2.

An eighth solution SOL8 may be applied to a preliminary window WIN-3d. The eighth solution SOL8 may be applied onto the second portion L2-2, and a third portion L3-2 may be formed. The eighth solution SOL8 may be substantially the same as the seventh solution SOL7.

The eighth solution SOL8 may be applied by the spray coating method. The spray nozzle SPY may apply the eighth solution SOL8 onto the second portion L2-2.

The eighth solution SOL8 may be applied along a path in a zigzag shape along the first direction DR1. For example, the eighth solution SOL8 may be applied in a ‘ [symbol] ’ shape along the first direction DR1. The eighth solution SOL8 may be applied onto the second portion L2-2 along the third path R3. The third path R3 may be substantially the same as the first path R1.

The eighth solution SOL8 applied onto the portion L2-2 may be formed into the third portion L3-2. The third portion L3-2 may be a liquid.

The portion L3-2 may be formed with a third thickness H3-2. The third thickness H3-2 may be in a range from 3.3 μm to 6.7 μm. The third thickness H3-2 may be substantially the same as the second thickness H2-2.

A preliminary window WIN-3e in which a first application process is completed may have a shape in which the first portion L1-2, the second portion L2-2, and the third portion L3-2 are sequentially stacked on the substrate 10.

The thickness H1-2 of the first portion L1-2, the thickness H2-2 of the second portion L2-2, and the thickness H3-2 of the third portion L3-2 may be substantially the same as each other.

FIGS. 15F and 15G are perspective views showing a process of a window manufacturing method according to an embodiment of the disclosure.

Referring to FIGS. 14, 15F, and 15G, a first coating layer L1a may be formed in a preliminary window WIN-3f (S330).

The curing module UVM may be disposed on the preliminary window WIN-3f. The curing module UVM may radiate the ultraviolet ray UV to the preliminary window WIN-3f. The curing module UVM may move along the second direction DR2.

The first portion L1-2, the second portion L2-2, and the third portion L3-2 may be cured simultaneously. The cured first portion L1-2, second portion L2-2, and third portion L3-2 may be referred to as the first coating layer L1a. That is, the first coating layer L1a may be formed in the multi-stage coating method. The first coating layer L1a may be a solid layer.

The first coating layer L1a may have a first thickness LH1. The first thickness LH1 may be in a range from 10 μm to 20 μm.

FIG. 15G shows the process of performing the plasma treatment on a surface of the first coating layer L1a (S430).

The plasma PS may be provided to a preliminary window WIN-3g. The plasma PS may pre-treat the surface of the first coating layer L1a.

FIGS. 15H to 15K are perspective views showing a process of a window manufacturing method according to an embodiment of the disclosure.

Referring to FIGS. 14, 15H, 15I, 15J, and 15K, the solution may be applied the plurality of times to form the plurality of portions (S530).

A ninth solution SOL9 may be applied to a preliminary window WIN-3h. The ninth solution SOL9 may be applied onto the first coating layer L1a, and a fourth portion L4-2 may be formed. The ninth solution SOL9 may be substantially the same as the sixth solution SOL6 (see FIG. 15A).

The ninth solution SOL9 may be applied by the spray coating method. The spray nozzle SPY may apply the ninth solution SOL9 to the surface of the first coating layer L1a.

The ninth solution SOL9 may be applied along a path in a zigzag shape along the first direction DR1. For example, the ninth solution SOL9 may be applied in a ‘ [symbol] ’ shape along the first direction DR1. The ninth solution SOL9 may be applied onto the first coating layer L1a along the first path R1.

The ninth solution SOL9 applied onto the first coating layer L1a may be formed into the fourth portion LA-2. The fourth portion L4-2 may be a liquid.

The portion LA-2 may be formed with a fourth thickness H4-2. The fourth thickness H4-2 may be in a range from 3.3 μm to 6.7 μm.

A tenth solution SOL10 may be applied to a preliminary window WIN-3i. The tenth solution SOL10 may be applied onto the fourth portion L4-2, and a fifth portion L5-2 may be formed. The tenth solution SOL10 may be substantially the same as the ninth solution SOL9.

The tenth solution SOL10 may be applied by the spray coating method. The spray nozzle SPY may apply the tenth solution SOL10 to a surface of the fourth portion L4-2.

The tenth solution SOL10 may be applied along a path in a zigzag shape along the direction opposite to the first direction DR1. For example, the tenth solution SOL10 may be applied in a ‘ [symbol] ’ shape along the direction opposite to the first direction DR1. The tenth solution SOL10 may be applied onto the fourth portion LA-2 along the second path R2.

The tenth solution SOL10 applied onto the portion L4-2 may be formed into the fifth portion L5-2. The fifth portion L5-2 may be a liquid.

The portion L5-2 may be formed with a fifth thickness H5-2. The fifth thickness H5-2 may be in a range from 3.3 μm to 6.7 μm. The fifth thickness H5-2 may be substantially the same as the fourth thickness H4-2.

An eleventh solution SOL11 may be applied to a preliminary window WIN-3j. The eleventh solution SOL11 may be applied onto the fifth portion L5-2, and a sixth portion L6-2 may be formed. The eleventh solution SOL11 may be substantially the same as the tenth solution SOL10.

The eleventh solution SOL11 may be applied by the spray coating method. The spray nozzle SPY may apply the eleventh solution SOL11 to a surface of the fifth portion L5-2.

The eleventh solution SOL11 may be applied along a path in a zigzag shape along the first direction DR1. For example, the eleventh solution SOL11 may be applied in a ‘ [symbol] ’ shape along the first direction DR1. The eleventh solution SOL11 may be applied onto the fifth portion L5-2 along the third path R3. The third path R3 may be substantially the same as the first path R1.

The eleventh solution SOL11 applied onto the portion L5-2 may be formed into the sixth portion L6-2. The sixth portion L6-2 may be a liquid.

The portion L6-2 may be formed with a sixth thickness H6-2. The sixth thickness H6-2 may be in a range from 3.3 μm to 6.7 μm. The sixth thickness H6-2 may be substantially the same as the fifth thickness H5-2.

A preliminary window WIN-3k in which the application process is completed may have a shape in which the fourth portion L4-2, the fifth portion L5-2, and the sixth portion L6-2 are sequentially stacked on the first coating layer L1a. The thickness H4-2 of the portion L4-2, the thickness H5-2 of the fifth

portion L5-2, and the thickness H6-2 of the sixth portion L6-2 may be substantially the same as each other.

FIGS. 15L to 15M are perspective views showing a process of a window manufacturing method according to an embodiment of the disclosure.

Referring to FIGS. 14, 15L, and 15M, a second coating layer L2a may be formed on the preliminary window WIN-3l (S630).

The curing module UVM may be disposed on a preliminary window WIN-3l. The curing module UVM may radiate the ultraviolet ray UV to the preliminary window WIN-3l. The curing module UVM may move along the second direction DR2.

The portion L4-2, the fifth portion L5-2, and the sixth portion L6-2 may be cured simultaneously. The cured fourth portion LA-2, fifth portion L5-2, and sixth portion L6-2 may be referred to as the second coating layer L2a. That is, the second coating layer L2a may be formed by the multi-stage coating method. The second coating layer L2a may be a solid layer.

The coating layer L2a may have a second thickness LH2. The second thickness LH2 may be in a range from 10 μm to 20 μm.

A window WIN-3 may be manufactured by such an embodiment of the window manufacturing method. The window WIN-3 may include the substrate 10 and a coating layer CL-2. The coating layer CL-2 may be disposed on the substrate 10. The coating layer CL-2 may improve the impact resistance of the substrate 10 and prevent the substrate 10 from being shattered or scattered when the substrate 10 is damaged.

The coating layer CL-2 may include the first coating layer L1a and the second coating layer L2a. Each of the first coating layer L1a and the second coating layer L2a may be formed by the multi-stage coating method, and the coating layer CL-2 may be formed by the multi-layer coating method. Forming the coating layer CL-2 using both the multi-stage coating and the multi-layer coating may be referred to as a hybrid coating method.

The coating layer CL-2 may have a predetermined thickness CH3. The thickness CH3 may be in a range from 20 μm to 40 μm.

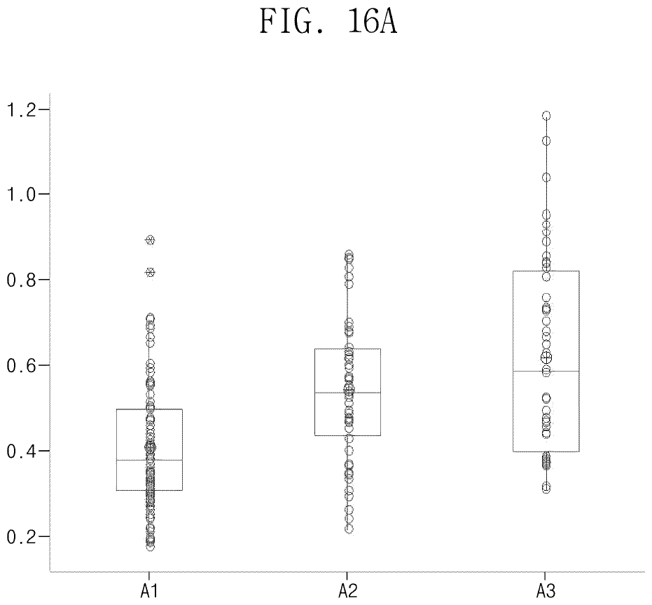

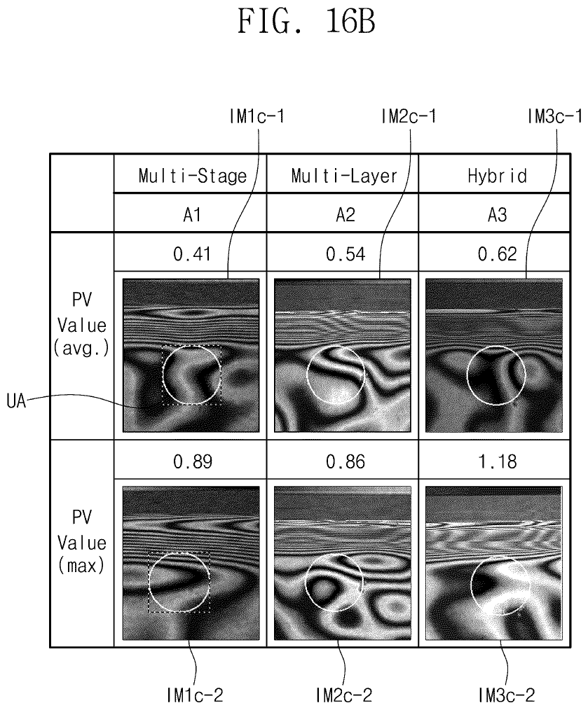

FIG. 16A is a box graph showing a PV value for each coating method according to an embodiment of the disclosure, and FIG. 16B shows captured images of a window for each coating method according to embodiments of the disclosure.

Referring to FIGS. 6J, 11J, 15M, 16A, and 16B, in FIG. 16A, a horizontal axis shows the window for each coating method, and a vertical axis shows the PV value. The PV value shows 0 wavelength to 1.2 wavelength as an example. In this regard, 1 wavelength may be about 632.8 nm.

The first window WIN-1 may be formed using a multi-stage coating A1 method, the second window WIN-2 may be formed using a multi-layer coating A2 method, and the third window WIN-3 may be formed using a hybrid coating A3 method.

That is, the coating layer CL of the first window WIN-1 may be formed using the multi-stage coating A1 method. The coating layer CL-1 of the second window WIN-2 may be formed using the multi-layer coating A2 method. The coating layer CL-2 of the third window WIN-3 may be formed using the hybrid coating A3 method.

Each of images IM1c-1 and IMIc-2 obtained by capturing the first window WIN-1, images IM2c-1 and IM2c-2 obtained by capturing the second window WIN-2, and images IM3c-1 and IM3c-2 obtained by capturing the third window WIN-3 shows the thickness of the coating layer via the level curve.

The coating layer CL of the first window WIN-1 may have a thickness CH1 of about 20 μm. In this regard, the average value of the PV values may be 0.41 wavelength, and the maximum value of the PV values may be 0.89 wavelength.

The image IM1c-1 and the first-second image IM1c-2 may be images obtained by capturing the first window WIN-1 including the coating layer CL formed via the multi-stage coating A1 method.

The image IM1c-1 may be an image obtained by capturing a top surface of the first window WIN-1 having the average value of the PV values. For example, the first-first image IM1c-1 may be an image obtained by capturing the top surface of the first window WIN-1 having the PV value of 0.41 wavelength.

The image IM1c-2 may be an image obtained by capturing the top surface of the first window WIN-1 having the maximum value of the PV values. For example, the first-second image IM1c-2 may be an image obtained by capturing the top surface of the first window WIN-1 having the PV value of 0.89 wavelength.

According to an embodiment of the disclosure, it may be defined that the edge bead phenomenon is reduced or eliminated when the PV value is equal to or greater than the 0.2 wavelength and equal to or smaller than the 0.92 wavelength. The first window WIN-1 may form the coating layer CL for improving the impact resistance of the substrate 10 by the multi-stage coating A1 method. The coating layer CL may have the PV value equal to or greater than the 0.2 wavelength and equal to or smaller than the 0.92 wavelength. In such an embodiment, the edge bead phenomenon in the sensor area UA may be reduced or eliminated such that the optical characteristics of the sensor area UA may be improved. Therefore, the first window WIN-1 with the improved impact resistance and flatness may be provided.

The coating layer CL-1 of the window WIN-2 may have the thickness CH2 of about 28 μm. In this regard, the average value of the PV values may be 0.54 wavelength, and the maximum value of the PV values may be 0.86 wavelength.

The image IM2c-1 and the second-second image IM2c-2 may be images obtained by capturing the second window WIN-2 including the coating layer CL-1 formed via the multi-layer coating A2 method.

The image IM2c-1 may be an image obtained by capturing a top surface of the second window WIN-2 having the average value of the PV values. For example, the second-first image IM2c-1 may be an image obtained by capturing the top surface of the second window WIN-2 having the PV value of 0.54 wavelength.

The image IM2c-2 may be an image obtained by capturing the top surface of the second window WIN-2 having the maximum value of the PV values. For example, the second-second image IM2c-2 may be an image obtained by capturing the top surface of the second window WIN-2 having the PV value of 0.86 wavelength.

According to an embodiment of the disclosure, it may be defined that the edge bead phenomenon is reduced or eliminated when the PV value is equal to or greater than the 0.2 wavelength and equal to or smaller than the 0.92 wavelength. The second window WIN-2 may form the coating layer CL-1 for improving the impact resistance of the substrate 10 by the multi-layer coating A2 method. The coating layer CL-1 may have the PV value equal to or greater than the 0.2 wavelength and equal to or smaller than the 0.92 wavelength. In such an embodiment, the edge bead phenomenon in the sensor area UA may be reduced or eliminated such that the optical characteristics of the sensor area UA may be improved. Therefore, the second window WIN-2 with the improved impact resistance and flatness may be provided.

The coating layer CL-2 of the window WIN-3 may have the thickness CH3 of about 35 μm. In this regard, the average value of the PV values may be 0.62 wavelength, and the maximum value of the PV values may have 1.18 wavelength.

The image IM3c-1 and the third-second image IM3c-2 may be images obtained by capturing the third window WIN-3 including the coating layer CL-2 formed via the hybrid coating A3 method. The hybrid coating A3 may be the process of forming the coating layer CL-2 using both the multi-stage coating A1 and the multi-layer coating A2 methods.

The third-first image IM3c-1 may be an image obtained by capturing a top surface of the third window WIN-3 having the average value of the PV values. For example, the third-first image IM3c-1 may be an image obtained by capturing the top surface of the third window WIN-3 having the PV value of 0.62 wavelength.

The image IM3c-2 may be an image obtained by capturing the top surface of the third window WIN-3 having the maximum value of the PV values. For example, the third-second image IM3c-2 may be an image obtained by capturing the top surface of the third window WIN-3 having the PV value of 1.18 wavelength.

According to an embodiment of the disclosure, it may be defined that the edge bead phenomenon is reduced or eliminated when the PV value is equal to or greater than the 0.2 wavelength and equal to or smaller than the 0.92 wavelength. The third window WIN-3 may form the coating layer CL-2 for improving the impact resistance of the substrate 10 by the hybrid coating A3 method. The coating layer CL-2 may have the PV value equal to or greater than the 0.2 wavelength and equal to or smaller than the 0.92 wavelength. In such an embodiment, the edge bead phenomenon in the sensor area UA may be reduced or eliminated such that the optical characteristics of the sensor area UA may be improved. Therefore, the third window WIN-3 with the improved impact resistance and flatness may be provided.

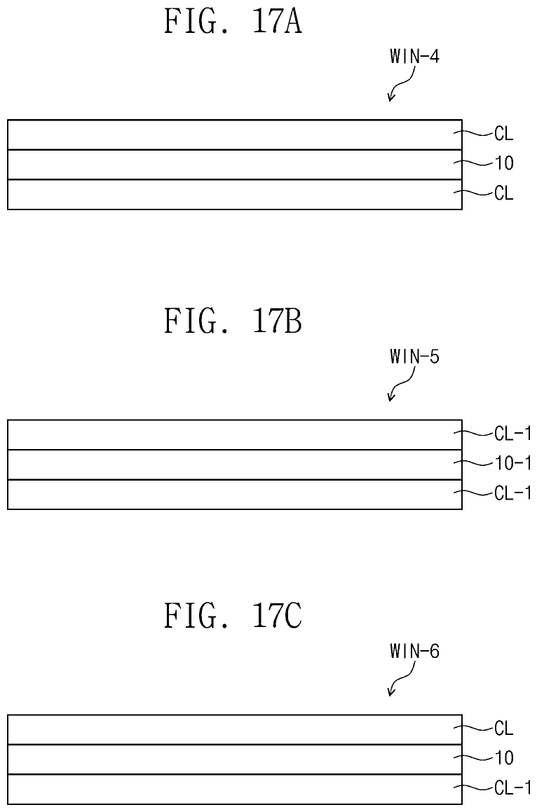

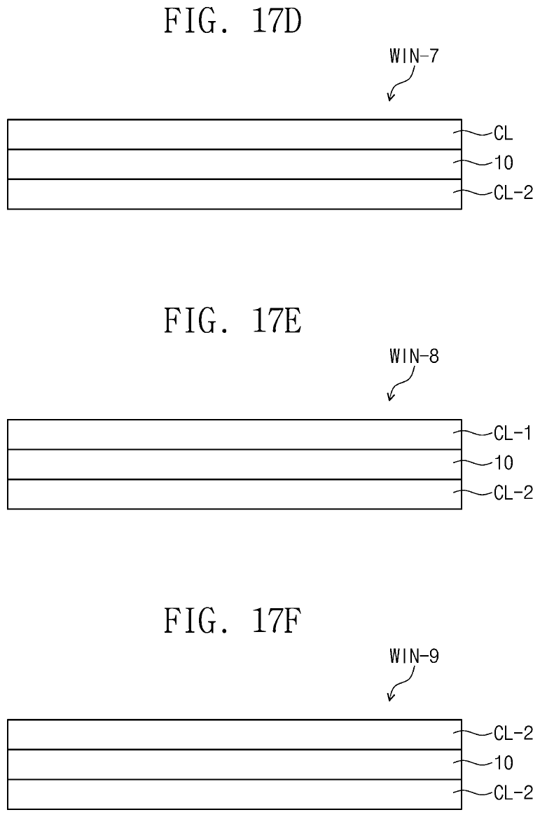

FIGS. 17A to 17F show windows according to embodiments of the disclosure.

Referring to FIG. 17A, an embodiment of a window WIN-4 may include the substrate 10 and two coating layers CL. The one coating layer CL may be disposed on the substrate 10, and the other coating layer CL may be disposed under the substrate 10. The other coating layer CL may be disposed opposite to the one coating layer CL. That is, the two coating layers CL may be spaced apart from each other with the substrate 10 interposed therebetween.

The one coating layer CL may be formed on the substrate 10, and then the other coating layer CL may be formed under the substrate 10.

Each of the two coating layers CL may be formed by the multi-stage coating method.

Referring to FIG. 17B, an embodiment of a window WIN-5 may include the substrate 10 and the two coating layers CL-1. The one coating layer CL-1 may be disposed on the substrate, and the other coating layer CL-1 may be disposed under the substrate 10. The other coating layer CL-1 may be disposed opposite to the one coating layer CL-1. That is, the two coating layers CL-1 may be spaced apart from each other with the substrate 10 interposed therebetween.

The one coating layer CL-1 may be formed on the substrate 10, and then the other coating layer CL-1 may be formed under the substrate 10.

Each of the two coating layers CL-1 may be formed by the multi-layer coating method.

Referring to FIG. 17C, an embodiment of window WIN-6 may include the substrate 10 and the two coating layers CL and CL-1 formed by different methods. The one coating layer CL may be disposed on the substrate, and the other coating layer CL-1 may be disposed under the substrate 10. The other coating layer CL-1 may be disposed opposite to the one coating layer CL. That is, the two coating layers CL and CL-1 may be spaced apart from each other with the substrate 10 interposed therebetween.

The one coating layer CL may be formed on the substrate 10, and then the other coating layer CL-1 may be formed under the substrate 10.

The one coating layer CL may be formed by the multi-stage coating method, and the other coating layer CL-1 may be formed by the multi-layer coating method.

Referring to FIG. 17D, an embodiment of a window WIN-7 may include the substrate 10 and the two coating layers CL and CL-2 formed by different methods. The one coating layer CL may be disposed on the substrate, and the other coating layer CL-2 may be disposed under the substrate. The other coating layer CL-2 may be disposed opposite to the one coating layer CL. That is, the two coating layers CL and CL-2 may be spaced apart from each other with the substrate 10 interposed therebetween.

The one coating layer CL may be formed on the substrate 10, and then the other coating layer CL-2 may be formed under the substrate 10.

The one coating layer CL may be formed by the multi-stage coating method, and the other coating layer CL-2 may be formed by the hybrid coating method.

Referring to FIG. 17E, an embodiment of window WIN-8 may include the substrate 10 and the two coating layers CL-1 and CL-2 formed by different methods. The one coating layer CL-1 may be disposed on the substrate, and the other coating layer CL-2 may be disposed under the substrate 10. The other coating layer CL-2 may be disposed opposite to the one coating layer CL-1. That is, the two coating layers CL-1 and CL-2 may be spaced apart from each other with the substrate 10 interposed therebetween.

The one coating layer CL-1 may be formed on the substrate 10, and then the other coating layer CL-2 may be formed under the substrate 10.

The one coating layer CL-1 may be formed by the multi-layer coating method, and the other coating layer CL-2 may be formed by the hybrid coating method.

Referring to FIG. 17F, an embodiment of window WIN-9 may include the substrate 10 and the two coating layers CL-2. The one coating layer CL-2 may be disposed on the substrate and the other coating layer CL-2 may be disposed under the substrate 10. The other coating layer CL-2 may be disposed opposite to the one coating layer CL-2. That is, the two coating layers CL-2 may be spaced apart from each other with the substrate 10 interposed therebetween.

The one coating layer CL-2 may be formed on the substrate 10, and then the other coating layer CL-2 may be formed under the substrate 10.

Each of the two coating layers CL-2 may be formed by the hybrid coating method.

In embodiments of the invention, as described above, it may be defined that the edge bead phenomenon is reduced or eliminated when the PV value, which is the difference between the maximum value and the minimum value (the peak to valley) of the wavefront aberration, is equal to or greater than the 0.2 wavelength and equal to or smaller than the 0.92 wavelength. In embodiments, the window may be applied with the coating layer for improving the impact resistance of the substrate the plurality of times. In such embodiments, the coating layer formed with the three application processes may have the PV value equal to or greater than the 0.2 wavelength and equal to or smaller than the 0.92 wavelength. Accordingly, in such embodiments, the edge bead phenomenon in the sensor area may be reduced or eliminated such that the optical characteristics of the sensor area may be improved. Therefore, the display device including the window with the improved impact resistance and flatness may be provided.

In addition, according to embodiments of the invention, the window may be formed with the coating layer for improving the impact resistance of the substrate that is formed of the plurality of layers. The coating layer that is formed of the two layers and has the predetermined thickness may have the PV value equal to or greater than the 0.2 wavelength and equal to or smaller than the 0.92 wavelength. In such embodiments, the edge bead phenomenon in the sensor area may be reduced or eliminated such that the optical characteristics of the sensor area may be improved. Therefore, the display device including the window with the improved impact resistance and flatness may be provided.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A method for manufacturing a window, the method comprising:
performing a plasma treatment on a surface of a substrate;
performing a first application operation to form a first portion by applying a first solution onto the substrate;
performing a second application operation to form a second portion by applying a second solution onto the first portion;
performing a third application operation to form a third portion by applying a third solution onto the second portion; and
forming a first coating layer by simultaneously curing the first to third portions.

2. The method of claim 1, wherein the first solution and the second solution include a same material as each other.

3. The method of claim 1, wherein the first portion has a thickness in a range from about 6.7 μm to about 10 μm,
wherein the second portion has a thickness in a range from about 6.7 μm to about 10 μm,
wherein the third portion has a thickness in a range from about 6.7 μm to about 10 μm.

4. The method of claim 1, wherein the performing the first application operation includes applying the first solution along a path in a zigzag shape along a first direction by using a spray coating method.

5. The method of claim 4, wherein the performing the second application operation includes applying the second solution along a path in the zigzag shape along a direction opposite to the first direction by using the spray coating method.

6. The method of claim 1, further comprising:
forming a second coating layer on the first coating layer after the forming the first coating layer.

7. The method of claim 6, wherein the forming the second coating layer includes:
performing the plasma treatment on a surface of the first coating layer;
forming a fourth portion by applying a fourth solution onto the first coating layer;
forming a fifth portion by applying a fifth solution onto the fourth portion;
forming a sixth portion by applying a sixth solution onto the fifth portion; and
simultaneously curing the fourth to sixth solutions.

8. The method of claim 6, wherein
each of the first coating layer and the second coating layer has a thickness in a range from about 20 μm to about 40 μm.

9. The method of claim 1, further comprising:
forming a third coating layer under the substrate after the forming the first coating layer.

10. A method for manufacturing a window, the method comprising:
performing a plasma treatment on a surface of a substrate;
performing a first application operation to form a first portion by applying a first solution onto the substrate;
forming a first layer by curing the first portion;
performing the plasma treatment on a surface of the first layer;
performing a second application operation to form a second portion by applying a second solution onto the first layer; and
forming a second layer by curing the second portion, wherein the first layer and the second layer collectively define a first coating layer.

11. The method of claim 10, wherein the first layer has a thickness in a range from 10 μm to 15 μm.

12. The method of claim 11, wherein
the second layer has a thickness in a range from about 10 μm to about 15 μm.

13. The method of claim 10, wherein the first solution does not include a leveling agent,
wherein the second solution includes the leveling agent.

14. The method of claim 10, wherein the performing the first application operation includes applying the first solution along a path in a zigzag shape along a first direction by using a spray coating method.

15. The method of claim 14, wherein the performing the second application operation includes applying the second solution along a path in the zigzag shape along the first direction by using the spray coating method.

16. The method of claim 10, further comprising:
forming a second coating layer under the substrate after the forming the first layer and the forming the second layer.

17. A display device comprising:
a display panel; and
a window disposed on the display panel,
wherein the window includes:
a substrate; and
a first coating layer disposed on the substrate,
wherein the first coating layer is a solid layer formed by curing a solution,
wherein the solution has a viscosity in a range from about 6 cps to about 10 cps,
wherein a difference between a maximum value and a minimum value of a wavefront aberration of the first coating layer is equal to or greater than 0.2 wavelength and equal to or smaller than 0.92 wavelength.

18. The display device of claim 17, wherein the first coating layer has a thickness in a range from about 20 μm to about 30 μm.

19. The display device of claim 17, wherein the first coating layer includes a first layer and a second layer stacked one on another therein,
wherein the first layer and the second layer include a same material as each other.

20. The display device of claim 17, further comprising:
a second coating layer disposed under the substrate and opposite to the first coating layer.
